(19) United States
(12) Patent Application Publication
(10) Pub. No.: US 2026/0142157 A1
(43) Pub. Date: May 21, 2026

(54) POSITIVE ELECTRODE ACTIVE MATERIAL, A POSITIVE ELECTRODE AND A LITHIUM SECONDARY BATTERY

(71) Applicants: HYUNDAI MOTOR COMPANY, Seoul (KR); KIA CORPORATION, Seoul (KR); KYONGGI UNIVERSITY INDUSTRY & ACADEMIA COOPERATION FOUNDATION, Suwon-si (KR)

(72) Inventors: Je Sik Park, Hwaseong-si (KR); Hong Seok Min, Hwaseong-si (KR); Jeong Hyun Seo, Hwaseong-si (KR); Im Sul Seo, Hwaseong-si (KR); Chung Bum Lim, Hwaseong-si (KR); Yong Seok Lee, Hwaseong-si (KR); Ju Yeong Seong, Hwaseong-si (KR); Joo Young Lee, Hwaseong-si (KR); Dae Ik Jang, Suwon-si (KR); Ha Young Ko, Suwon-si (KR); Su Hyun Kwak, Suwon-si (KR); Da Eun Kim, Ansan-si (KR); Yong Joon Park, Seoul (KR)

(73) Assignees: HYUNDAI MOTOR COMPANY, Seoul (KR); KIA CORPORATION, Seoul (KR); KYONGGI UNIVERSITY INDUSTRY & ACADEMIA COOPERATION FOUNDATION, Suwon-si (KR)

(21) Appl. No.: 19/203,999

(22) Filed: May 9, 2025

(30) Foreign Application Priority Data
Nov. 15, 2024 (KR) 10-2024-0163362

(51) Int. Cl. H01M 4/36; H01M 4/02; H01M 4/525; H01M 4/58; H01M 10/052; H01M 10/0562

(52) U.S. Cl. CPC H01M 4/366; H01M 4/525; H01M 4/5815; H01M 10/052; H01M 10/0562; H01M 2004/028; H01M 2300/008

(57) ABSTRACT

Disclosed is a positive electrode active material including a surface-modified area that has artificially formed an interfacial reaction product on a surface of a lithium transition metal composite oxide particle through sulfur (S), thereby suppressing side reactions between the positive electrode active material and a sulfide-based solid electrolyte, while improving compatibility, thereby improving the life and rate performance of an all-solid-state lithium secondary battery. Further, a positive electrode including the same, and an all-solid-state lithium secondary battery including the same are disclosed.

### CROSS-REFERENCE TO RELATED APPLICATION

This application claims priority to Korean Patent Application No. 10-2024-0163362, filed in the Korean Intellectual Property Office on Nov. 15, 2024, the entire contents of which are incorporated herein by reference.

### TECHNICAL FIELD

The present disclosure relates to a positive electrode active material for an all-solid-state battery, a positive electrode including the same, and an all-solid-state lithium secondary battery.

### BACKGROUND

A lithium secondary battery using a liquid electrolyte is mainly used as a secondary battery using lithium ions. A lithium secondary battery using a liquid electrolyte generally has a negative electrode and a positive electrode separated from each other via a separator made of a polymer, and employs a liquid electrolyte as an electrolyte. However, a lithium secondary battery using such a liquid electrolyte has various safety issues because the electrolyte exists in a liquid state within the battery.

Therefore, development of an all-solid-state battery that employs a solid electrolyte instead of a liquid electrolyte as the electrolyte of a lithium secondary battery is continuing. The all-solid-state battery includes a negative electrode, a positive electrode, and a solid electrolyte, and all components of the battery are solid. Thus, the all-solid-state battery may prevent safety issues caused by the liquid electrolyte compared to the lithium secondary batteries that use liquid electrolytes.

In an all-solid-state lithium secondary battery that uses an inorganic solid electrolyte, in particular, a sulfide-based solid electrolyte is evaluated as being able to be commercialized due to excellent ion conductivity and bonding with an electrode active material. However, the sulfide-based solid electrolyte causes a side reaction with the positive electrode active material as an oxide, thereby forming a side reaction product at an interface. This reaction product results in a resistance layer at the interface between the positive electrode and the sulfide-based solid electrolyte, thereby acting as a major cause of deteriorating the electrochemical characteristics of all-solid-state lithium secondary batteries. To prevent this problem, a scheme has been proposed to coat a surface of the positive electrode active material with an oxide such as lithium zirconate (Li₂ZrO₃), lithium niobate (LiNbO₃), and lithium tantalate (LiTaO₃), or phosphate such as lithium phosphate (Li₃PO₄) which are stable in the sulfide-based solid electrolyte. Furthermore, in order to solve the contact problem between the positive electrode and the solid electrolyte, a scheme of coating an area of the positive electrode active material with the oxide or phosphate and then additionally coating the positive electrode active material with the sulfide-based solid electrolyte has been proposed. In this way, when additionally coating the sulfide-based solid electrolyte onto the positive electrode active material having the oxide or phosphate coated thereon, the sulfide-based solid electrolyte is present in a liquid state in an organic solvent and then is coated on the oxide or phosphate coating layer. However, when coating the positive electrode active material with the sulfide-based solid electrolyte as described above, there is a problem that the ionic conductivity of the sulfide-based solid electrolyte is rapidly reduced during the process of dispersing the sulfide-based solid electrolyte in the organic solvent, and the thus formed coating layer acts as a new resistance layer. Furthermore, when coating the positive electrode active material with the sulfide-based solid electrolyte as described above, there is a problem that it is difficult to thinly and uniformly coat the sulfide-based solid electrolyte layer on the surface of the positive electrode active material due to the high difficulty of the liquefaction process of the coating solution.

The coating material such as the oxide or phosphate currently used may significantly reduce the side reaction between the positive electrode active material and the sulfide-based solid electrolyte. However, since the coating material such as oxide or phosphate above are the oxide or phosphate similar to the positive electrode active material, the positive electrode active material having the coating material coated thereon also cannot help but have low compatibility with the sulfide-based solid electrolyte. Therefore, when the battery operates for a long time, the stability of the coating layer of the oxide or phosphate is not guaranteed, and it is difficult to maintain stable contact thereof with the sulfide-based solid electrolyte for a long time.

### SUMMARY

The present disclosure has been made to solve the above-mentioned problems occurring in the prior art while advantages achieved by the prior art are maintained.

A purpose of the present disclosure is to provide a positive electrode active material for an all-solid-state lithium secondary battery including a sulfide-based solid electrolyte, wherein the positive electrode active material suppresses side reactions between the positive electrode active material and the sulfide-based solid electrolyte while improving compatibility therebetween.

In other words, a purpose of the present disclosure is to provide a positive electrode active material that includes a surface-modified area that has artificially formed an interfacial reaction product on a particle surface via sulfur(S), thereby suppressing side reactions between the positive electrode active material and the sulfide-based solid electrolyte, and, at the same time, improving compatibility, thereby improving the life and rate performance of an all-solid-state lithium secondary battery.

Furthermore, a purpose of the present disclosure is to provide a positive electrode including the positive electrode active material.

Furthermore, a purpose of the present disclosure is to provide a lithium secondary battery including the positive electrode.

The technical problems to be solved by the present disclosure are not limited to the aforementioned problems, and any other technical problems not mentioned herein should be clearly understood from the following description by those having ordinary skill in the art to which the present disclosure pertains.

In order to achieve the above-mentioned purpose, the present disclosure provides a positive electrode active material, a positive electrode, and a lithium secondary battery.

The present disclosure provides a positive electrode active material comprising: a lithium transition metal composite oxide particle; and a surface-modified area present on at least a portion of a surface of the particle, wherein the surface-modified area includes a compound represented by a following Chemical Formula 1:

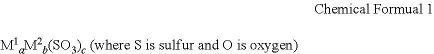

Wherein in the Chemical Formula 1, M¹ includes at least one selected from the group consisting of lithium (Li), boron (B), phosphate (P), niobium (Nb), zirconium (Zr), aluminum (Al), titanium (Ti), and tantalum (Ta), M² includes at least one selected from the group consisting of nickel (Ni), cobalt (Co), manganese (Mn), and iron (Fe), a satisfies 0≤a≤2, b satisfies 0≤b≤4, c satisfies 1≤c≤4, and at least one of a or b is not 0.

The present disclosure provides the positive electrode active material above, wherein the surface-modified area includes a compound represented by a following Chemical Formula 2:

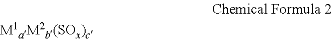

Wherein in the Chemical Formula 2, M¹ includes at least one selected from the group consisting of Li, B, P, Nb, Zr, Al, Ti, and Ta, M² includes at least one selected from the group consisting of Ni, Co, Mn, and Fe, a′ satisfies 0≤a′≤2, b′ satisfies 0≤b′≤4, c′ satisfies 1≤c′≤4, and at least one of a′ or b′ is not 0, and x satisfies 1≤x≤3 or 3<x≤10.

The present disclosure provides the positive electrode active material above, wherein in the surface-modified area, a molar ratio of M² to M¹ satisfies a following Relationship 1:

$$0 < [ {M}^{2} ] / [ {M}^{1} ] \leq 0.5 \qquad Relationship 1$$

Wherein in the Relationship 1, M¹ includes at least one selected from the group consisting of Li, B, P, Nb, Zr, Al, Ti, and Ta, M² includes at least one selected from the group consisting of Ni, Co, Mn, and Fe.

The present disclosure provides the positive electrode active material above, wherein the surface-modified area includes a metal sulfide.

The present disclosure provides the positive electrode active material above, wherein the surface-modified area contains the compound represented by the Chemical Formula 1 among components including the S element at a highest content.

The present disclosure provides the positive electrode active material above, wherein a content of the S element in the positive electrode active material as identified by inductively coupled plasma optical emission spectroscopy (ICP-OES) analysis is in a range of 200 ppm inclusive to 20,000 ppm inclusive.

The present disclosure provides the positive electrode active material above, wherein a distance between an outermost surface (OSM) of the positive electrode active material including the surface-modified area and an interface (ICP) of the surface-modified area and the surface of the particle is defined as A, wherein a point in the surface-modified area having a distance from the interface or the OSM being 50% of A is defined as a point (A₅₀), wherein a concentration of the S element in an area (OSM-A₅₀) between the outermost surface (OSM) of the positive electrode active material including the surface-modified area and the point (A₅₀) as identified by X-ray Photoelectron Spectroscopy (XPS) analysis is higher than a concentration of the S element in an area (A₅₀-ICP) between the point (A₅₀) and the interface (ICP) between the surface-modified area and the surface of the particle as identified by XPS analysis.

The present disclosure provides the positive electrode active material above, wherein the concentration of the S element in the area (A₅₀-ICP) between the point (A₅₀) and the interface (ICP) between the surface-modified area and the surface of the particle has a concentration gradient such that the concentration gradually decreases as the area extends from the point (A₅₀) toward the interface (ICP) between the surface-modified area and the surface of the particle.

The present disclosure provides the positive electrode active material above, wherein the positive electrode active material further comprises a coating area present on at least a portion of the surface of the particle.

The present disclosure provides the positive electrode active material above, wherein the coating includes at least one selected from the group consisting of lithium carbonate (Li₂CO₃), lithium hydroxide (LiOH), and a compound represented by a following Chemical Formula 3:

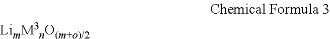

Wherein in the Chemical Formula 3, M³ is at least one selected from the group consisting of Nb, B, P, tungsten (W), Ti, Ta, tin (Sn), Zr, and Al, m satisfies 1≤m≤10, n satisfies 1≤n≤10, and o is an oxidation number of M³.

The present disclosure provides the positive electrode active material above, wherein the surface-modified area is present on at least a portion of a surface of the coating area.

The present disclosure provides the positive electrode active material above, wherein the positive electrode active material is free of a bond (S—P) of a S element and a P element.

The present disclosure provides the positive electrode active material above, wherein the lithium transition metal composite oxide particle includes at least one selected from the group consisting of a single crystal single-particle, a polycrystalline single-particle, and a secondary particle in which multiple primary particles are aggregated with each other.

The present disclosure provides the positive electrode active material above, wherein the lithium transition metal composite oxide particle has an average composition represented by a following Chemical Formula 4:

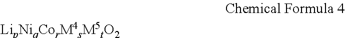

Wherein in the Chemical Formula 4, M⁴ includes Mn, Al, or a combination thereof, M⁵ includes at least one selected from the group consisting of Nb, Ta, B, Zr, chromium (Cr), and W, and p satisfies 0.8≤p≤1.3, q satisfies 0≤q<1, r satisfies 0<r<1, s satisfies 0<s<1, t satisfies 0≤t≤0.2, and q+r+s+t=1.

The present disclosure provides the positive electrode active material above, wherein q satisfies 0.8≤q<1, r satisfies 0<r≤0.2, s satisfies 0<s≤0.2, and t satisfies 0≤t≤0.1.

The present disclosure provides a positive electrode comprising the positive electrode active material described above.

The present disclosure provides a lithium secondary battery comprising the positive electrode described above.

The present disclosure provides the lithium secondary battery above, wherein the lithium secondary battery further comprises a negative electrode, and a solid electrolyte layer interposed between the positive electrode and the negative electrode.

The present disclosure provides the lithium secondary battery above, wherein the solid electrolyte layer includes a sulfide-based solid electrolyte.

The present disclosure provides the lithium secondary battery above, wherein the sulfide-based solid electrolyte includes an argyrodite-type sulfide-based solid electrolyte.

### BRIEF DESCRIPTION OF THE DRAWINGS

The above and other objects, features and advantages of the present disclosure should be more apparent from the following detailed description taken in conjunction with the accompanying drawings:

FIG. 1 is a cross-sectional view showing a stacked configuration of an all-solid-state lithium secondary battery according to an embodiment of the present disclosure;

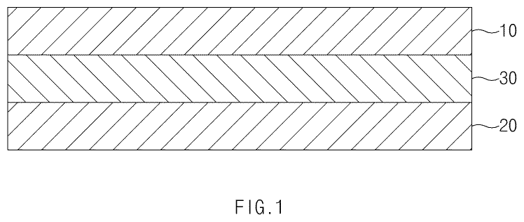

FIG. 2 is a cross-sectional view showing a formation location of a surface-modified area of a positive electrode active material according to an embodiment of the present disclosure;

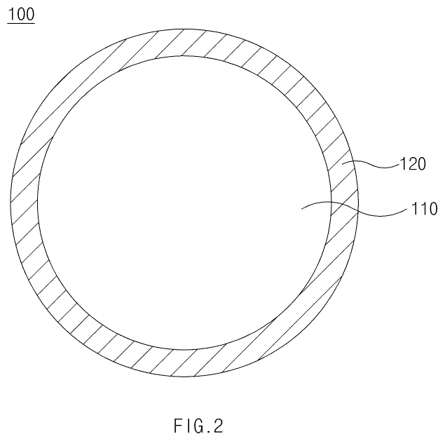

FIG. 3 is a cross-sectional view showing a formation location of a coating area and a surface-modified area of a positive electrode active material according to an embodiment of the present disclosure;

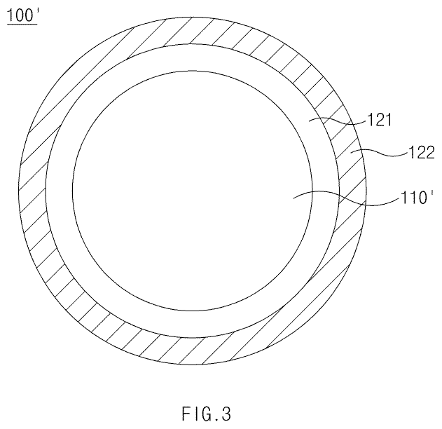

FIG. 4 is a graph showing an intensity of each of SO⁻, PO⁻, LiS⁻, and PS⁻ ions (where S is sulfur, O is oxygen, P is phosphorus, and Li is lithium) based on a sputtering time while sputtering from a material surface during TOF-SIMS analysis of Reference Example 1 of the present disclosure;

FIG. 5 is a graph showing an intensity of each of SO⁻, PO⁻, LiS⁻, and PS⁻ ions based on a sputtering time while sputtering from a material surface during TOF-SIMS analysis of Reference Example 2 of the present disclosure;

FIG. 6 is a graph showing an intensity of each of SO⁻, PO⁻, LiS⁻, and PS⁻ ions based on a sputtering time while sputtering from a material surface during TOF-SIMS analysis of Reference Example 3 of the present disclosure;

FIG. 7 is a graph showing an intensity of each of SO⁻, PO⁻, LiS⁻, and PS⁻ ions based on a sputtering time while sputtering from a material surface during TOF-SIMS analysis of Reference Example 4 of the present disclosure;

FIG. 8 is a graph showing a result of XPS analysis of each of Reference Examples 1 to 4 of the present disclosure, and showing a result on S 2p.

FIG. 9 is a graph showing a result of XPS analysis of a positive electrode active material prepared in Present Example 3 of the present disclosure;

FIG. 10 is a graph showing a result of XPS analysis of a positive electrode active material prepared in Present Example 9 of the present disclosure;

FIG. 11 is a graph showing an XPS analysis result of a positive electrode active material prepared in Comparative Example 1 of the present disclosure;

FIG. 12 is a graph showing an XPS analysis result of a positive electrode active material prepared in Comparative Example 2 of the present disclosure;

FIG. 13 is a graph showing an intensity of each of Nio⁻, SO⁻, PO⁻, LiS⁻, and PS⁻ ions (where Ni is nickel) based on a sputtering time while sputtering from a material surface of a positive electrode active material during TOF-SIMS analysis of Present Example 3 of the present disclosure;

FIG. 14 is a graph showing an intensity of each of Nio⁻, SO⁻, PO⁻, LiS⁻, and PS⁻ ions based on a sputtering time while sputtering from a material surface of a positive electrode active material during TOF-SIMS analysis of Present Example 9 of the present disclosure;

FIG. 15 is a graph showing an intensity of each of Nio⁻, SO⁻, PO⁻, LiS⁻, and PS⁻ ions based on a sputtering time while sputtering from a material surface of a positive electrode active material during TOF-SIMS analysis of Comparative Example 1 of the present disclosure;

FIG. 16 is a graph showing an intensity of each of Nio⁻, SO⁻, PO⁻, LiS⁻, and PS⁻ ions based on a sputtering time while sputtering from a material surface of a positive electrode active material during TOF-SIMS analysis of Comparative Example 2 of the present disclosure;

FIG. 17 is a graph showing a mass-to-charge ratio (Peak M/Z, ±0.03) at which a peak of each of SO₃⁻ and SO₄⁻ appears during TOF-SIMS analysis of Present Example 3 of the present disclosure;

FIG. 18 is a graph showing a mass-to-charge ratio (Peak M/Z, +0.03) at which a peak of each of SO₃⁻ and SO₄⁻ appears during TOF-SIMS analysis of Present Example 9 of the present disclosure;

FIG. 19 is a graph showing a mass-to-charge ratio (Peak M/Z, +0.03) at which a peak of each of SO₃⁻ and SO₄⁻ appears during TOF-SIMS analysis of Comparative Example 1 of the present disclosure;

FIG. 20 is a graph showing a mass-to-charge ratio (Peak M/Z, +0.03) at which a peak of each of SO₃⁻ and SO₄⁻ appears during TOF-SIMS analysis of Comparative Example 2 of the present disclosure;

FIG. 21 is a graph showing an XPS depth analysis results of Present Example 3 of the present disclosure;

FIG. 22 is a graph showing an XPS depth analysis result of Present Example 8 of the present disclosure;

FIG. 23 is a graph showing an XPS depth analysis result of Present Example 9 of the present disclosure;

FIG. 24 is a graph showing an XPS depth analysis result of Comparative Example 1 of the present disclosure;

FIG. 25 is a graph showing an XPS depth analysis result of Comparative Example 2 of the present disclosure;

FIG. 26 is a graph showing a comparison between initial discharge capacities of all-solid-state lithium secondary batteries respectively including the positive electrode active materials respectively prepared in Present Examples 1-8 and Comparative Example 1 of the present disclosure;

FIG. 27 is a graph showing a comparison between DC (direct current) resistances of all-solid-state lithium secondary batteries respectively including the positive electrode active materials respectively prepared in Present Examples 1-8 and Comparative Example 1 of the present disclosure;

FIG. 28 is a graph showing a specific capacity of each of all-solid-state lithium secondary batteries respectively including the positive electrode active materials respectively prepared in Present Examples 3 and 9 and Comparative Examples 1 and 2 of the present disclosure;

FIG. 29 is a graph showing an initial charge/discharge capacity of each of all-solid-state lithium secondary batteries respectively including the positive electrode active materials respectively prepared in Present Examples 3 and 9 and Comparative Examples 1 and 2 of the present disclosure;

FIG. 30 is a graph showing an GITT analysis results measured after 300 charge/discharge cycles of each of all-solid-state lithium secondary batteries respectively including the positive electrode active materials respectively prepared in Present Examples 3 and 9 and Comparative Examples 1 and 2 of the present disclosure;

FIG. 31 is a graph showing a specific capacity after 300 charge/discharge cycles of each of all-solid-state lithium secondary batteries respectively including the positive electrode active materials respectively prepared in Present Example 3 and 9 and Comparative Examples 1 and 2 of the present disclosure;

FIG. 32 is a TEM image of a separated positive electrode active material after 300 charge/discharge cycles of an all-solid-state lithium secondary battery including a positive electrode active material prepared in Present Example 3 of the present disclosure.

FIG. 33 is a TEM image of a separated positive electrode active material after 300 charge/discharge cycles of an all-solid-state lithium secondary battery including a positive electrode active material prepared in Present Example 9 of the present disclosure.

FIG. 34 is a TEM image of a separated positive electrode active material after 300 charge/discharge cycles of an all-solid-state lithium secondary battery including a positive electrode active material prepared in Comparative Example 1 of the present disclosure; and

FIG. 35 is a TEM image of a separated positive electrode active material after 300 charge/discharge cycles of an all-solid-state lithium secondary battery including a positive electrode active material prepared in Comparative Example 2 of the present disclosure.

### DETAILED DESCRIPTION

Hereinafter, the present disclosure is described in more detail.

Terms or words used in this specification and claims should not be interpreted as limited to their usual or dictionary meanings, and should be interpreted as meanings and concepts that comply with the technical ideas of the present disclosure based on the principle that the inventor may appropriately define the concept of the term in order to explain his or her own invention in the best way.

A positive electrode active material, a positive electrode, and/or a lithium secondary battery according to the present disclosure may include at least one of following disclosed configurations, and may include any combination of technically possible configurations among the following disclosed configurations.

### Positive Electrode Active Material

The present disclosure provides a positive electrode active material.

According to an embodiment of the present disclosure, the positive electrode active material may include a surface-modified area that has artificially formed an interfacial reaction product on a surface of a lithium transition metal composite oxide particle via sulfur(S) to suppress side reactions between the positive electrode active material and the sulfide-based solid electrolyte while improving compatibility. Therefore, the positive electrode active material may be particularly useful for an all-solid-state lithium secondary battery including a sulfide-based solid electrolyte.

According to an embodiment of the present disclosure, the positive electrode active material 100 and 100′ may include a lithium transition metal composite oxide particle 110 and 110′; and a surface-modified area 120 and 122 present on at least a portion of a surface of the particle, wherein the surface-modified area may include a compound represented by a following Chemical Formula 1.

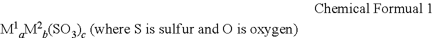

In the Chemical Formula 1, M¹ includes at least one selected from the group consisting of lithium (Li), boron (B), phosphorus (P), niobium (Nb), zirconium (Zr), aluminum (Al), titanium (Ti), and tantalum (Ta), and M² includes at least one selected from the group consisting of nickel (Ni), cobalt (Co), manganese (Mn), and iron (Fe), and a satisfies 0≤a≤2, b satisfies 0≤b≤4, c satisfies 1≤c≤4, and at least one of a and b is not 0.

According to an embodiment of the present disclosure, the compound represented by the Chemical Formula 1 may be a compound formed through a reaction between the surface of the lithium transition metal composite oxide particle and sulfur(S). In a specific example, the compound represented by the Chemical Formula 1 may be a compound formed by artificially reacting the lithium transition metal composite oxide and sulfur(S) with each other. In this regard, the M¹ may be a metal element derived from at least one selected from the group consisting of residual lithium present on the surface of the lithium transition metal composite oxide particle, doping elements, and coating elements. The M² may be a metal element derived from a transition metal element existing on the surface of the lithium transition metal composite oxide particle.

According to an embodiment of the present disclosure, the compound represented by the Chemical Formula 1 may be at least one selected from a group of compounds including M¹ and/or M² and SO₃²⁻ ions. In a specific example, the compound represented by the Chemical Formula 1 may be at least one selected from a group consisting of CoSO₃, MnSO₃, NiSO₃, Li₂SO₃, Li₂Co(SO₃)₂, Li₂Mn (SO₃)₂, Li₂Ni (SO₃)₂, LiB (SO₃)₂, and PO₂SO₃.

According to an embodiment of the present disclosure, the surface-modified area may include a compound represented by a following Chemical Formula 2.

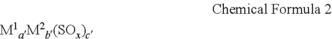

In the Chemical Formula 2, M₁ includes at least one selected from the group consisting of Li, B, P, Nb, Zr, Al, Ti, and Ta, and M² includes at least one selected from the group consisting of Ni, Co, Mn, and Fe, a′ satisfies 0≤a′≤2, b′ satisfies 0≤b′≤4, c′ satisfies 1≤c′≤4, and at least one of a′ and b′ is not 0, and x satisfies 1≤x<3 or 3<x≤10.

According to an embodiment of the present disclosure, the compound represented by the Chemical Formula 2 may be a compound formed by a reaction between the surface of a lithium transition metal composite oxide particle and sulfur(S). In a specific example, the compound represented by the Chemical Formula 2 may be a compound formed by artificially reacting lithium transition metal composite oxide and sulfur(S) with each other.

According to an embodiment of the present disclosure, the compound represented by the Chemical Formula 2 may be at least one selected from a group of compounds including M¹ and/or M² and a sulfur oxide ion. Specific examples thereof include at least one selected from a group consisting of P₄(SO₂)₃, CoSO₄, MnSO₄, NiSO₄, Li₂SO₄, Li₂Co (SO₄)₂, Li₂Mn (SO₄)₂, Li₂Ni (SO₄)₂, LiB (SO₄)₂, CoSO₅, CoSO₁₀, Co₃ (SO₆)₂, MnSO₅, MnSO₆, Ni (SO₆)₂, NiSO₅, NiSO₉, NiSO₁₀, P₂S₂O₃, P₄SO₆, P₄SO₇, Nb₂S₃O₁₄, Nb₈S₈O₄₅, and B₂S₂O₉.

According to an embodiment of the present disclosure, in the surface-modified area, a molar ratio of M² to M¹ satisfies a following Relationship 1;

$$0 < [ {M}^{2} ] / [ {M}^{1} ] \leq 0.5 \qquad Relationship 1$$

In the Relationship 1, M¹ includes at least one selected from the group consisting of Li, B, P, Nb, Zr, Al, Ti, and Ta, and M² includes at least one selected from the group consisting of Ni, Co, Mn, and Fe. According to computational science, the nearest neighbor hopping activation energy (NNH Ea) of Li₂SO₄ is 286 meV, and 1d diffusion energy thereof is 737 meV. On the other hand, the NNH Ea of Li₂Ni (SO₄)₂ is 987 meV, the 1d diffusion energy thereof is 1,609 meV, and the NNH Ea of Li₂Co (SO₄)₂ and Li₂Mn (SO₄)₂ are 1,128 MeV and 1,841 MeV, respectively. The Li—Li distance of Li₂Co (SO₄)₂ is 4.84 Å, and the Li—Li distance of Li₂Mn (SO₄)₂ is 4.92 Å, thus making it difficult to create a diffusion path. In other words, when the molar content of M¹ is greater than the molar content of M², specifically, when the above Relationship 1 is satisfied, the activation energy of lithium ion conduction may be lowered, so that the lithium ion conductivity may be further improved and the interfacial resistance may be further reduced. According to an embodiment of the present disclosure, the surface-modified area may include a metal sulfide. The above metal sulfide may be at least one selected from the group consisting of metal sulfides in which lithium and/or transition metal is combined with sulfur(S), such as Li₂S, NiS, CoS, MnS, etc.

According to an embodiment of the present disclosure, the surface-modified area may contain the compound represented by the Chemical Formula 1 among the components including the S element at the highest content. In a specific example, the surface-modified area may include the compound represented by the Chemical Formula 1, and optionally the compound represented by the Chemical Formula 2, and/or the metal sulfide at the same time. In this case, the surface-modified area may contain the compound represented by the Chemical Formula 1 as a dominant species, i.e., at the highest content. In this way, when the compound represented by the Chemical Formula 1 is contained in the surface-modified area at the highest content, additional side reactions between the positive electrode active material and the sulfide-based solid electrolyte may be further suppressed.

According to an embodiment of the present disclosure, the positive electrode active material may have a content of the S element in a range of 200 ppm inclusive to 20,000 ppm inclusive as identified based on ICP-OES analysis. In a specific example, the positive electrode active material has a content of the S element as identified by ICP-OES analysis in a range of 200 ppm or greater, 225 ppm or greater, 250 ppm or greater, 275 ppm or greater, 300 ppm or greater, 325 ppm or greater, 350 ppm or greater, 375 ppm or greater, 400 ppm or greater, 425 ppm or greater, 450 ppm or greater, 475 ppm or greater, 500 ppm or greater, 525 ppm or greater, 550 ppm or greater, 575 ppm or greater, 600 ppm or greater, 625 ppm or greater, 650 ppm or greater, 675 ppm or greater, 700 ppm or greater, 725 ppm or greater, 750 ppm or greater, 775 ppm or greater, 800 ppm or greater, 825 ppm or greater, 850 ppm or greater, 875 ppm or greater, 900 ppm or greater, 925 ppm or greater, 950 ppm or greater, or 975 ppm or greater, and 20,000 ppm or lower, 19,500 ppm or lower, 19,000 ppm or lower, 18, 500 ppm or lower, 18,000 ppm or lower, 17,500 ppm or lower, 17,000 ppm or lower, 16,500 ppm or lower, 16,000 ppm or lower, 15,500 ppm or lower, 15,000 ppm or lower, 14,500 ppm or lower, 14,000 ppm or lower, 13,500 ppm or lower, 13,000 ppm or lower, 12,500 ppm or lower, 12,000 ppm or lower, 11, 500 ppm or lower, 11,000 ppm or lower, 10,500 ppm or lower, 10,000 ppm or lower, 9,500 ppm or lower, 9,000 ppm or lower, 8,500 ppm or lower, 8,000 ppm or lower, 7,500 ppm or lower, 7,000 ppm or lower, 6,500 ppm or lower, 6,000 ppm or lower, 5,500 ppm or lower, 5,000 ppm or lower, 4,500 ppm or lower, 4,000 ppm or lower, 3,500 ppm or lower, or 3,000 ppm or lower. When the positive electrode active material includes the S element in the above content, this may prevent the surface-modified area from becoming unnecessarily thick, and thus prevent the mobility of lithium ions from being reduced due to the surface-modified area, thereby preventing a decrease in electrochemical characteristics.

According to an embodiment of the present disclosure, when a distance between the outermost surface (OSM) of the positive electrode active material including the surface-modified area and an interface (ICP) between the surface-modified area and the surface of the particle is defined as A. A point in the surface-modified area having a distance from the interface or the OSM being 50% of A is defined as the point (A₅₀). A concentration of the S element in an area (OSM-A₅₀) between the outermost surface (OSM) of the positive electrode active material including the surface-modified area and the point (A₅₀) as identified by XPS analysis may be higher than a concentration of the S element in an area (A₅₀-ICP) between the point (A₅₀) and the interface (ICP) between the surface-modified area and the surface of the particle. In a specific example, the concentration of the S element in the area (A₅₀-ICP) between the point (A₅₀) and the interface (ICP) between the surface-modified area and the surface of the particle may have a concentration gradient such that the concentration gradually decreases as the area extends from the point (A₅₀) toward the interface (ICP) between the surface-modified area and the surface of the particle. When the concentration of the S element of the surface-modified area is adjusted as described above, a sulfidation of a contact portion thereof with the sulfide-based solid electrolyte may be increased, thereby maximizing the control of the side reaction.

According to an embodiment of the present disclosure, the positive electrode active material 100′ may include a coating area 121 present on at least a portion of the surface of the particle. The coating area may include a residual lithium compound present on the surface of the lithium transition metal composite oxide particle. Furthermore, the coating area may be derived from a coating area previously formed on the lithium transition metal composite oxide particle prior to forming the surface-modified area on the surface of the lithium transition metal composite oxide particle. In a specific example, the coating area may include at least one selected from the group consisting of lithium carbonate (Li₂CO₃), lithium hydroxide (LiOH), and a compound represented by a following Chemical Formula 3. The Li₂CO₃ and LiOH may be derived from the residual lithium compound, and the compound represented by the following Chemical Formula 3 may be a component contained in the coating area previously formed on the surface of the lithium transition metal composite oxide particle.

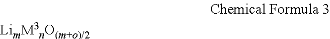

In the Chemical Formula 3, M³ is at least one selected from the group consisting of Nb, B, P, tungsten (W), Ti, Ta, tin (Sn), Zr, and Al, m satisfies 1≤m≤10, n satisfies 1≤n≤10, and o is the oxidation number of M³.

According to an embodiment of the present disclosure, the surface-modified area may be formed in the presence of the coating area, and thus, the surface-modified area 122 may be present on at least a portion of a surface of the coating area 121. In a specific example, when the coating area is formed on a portion of the lithium transition metal compound particle surface, the surface-modified area may be formed and present on at least a portion or an entirety of the surface of the lithium transition metal compound particle surface on which the coating area is not formed, and/or on at least a portion or an entirety of a surface of the coating area. Furthermore, the surface-modified area may be present only on the lithium transition metal compound particle surface on which the coating area is not formed, or may be present only on at least a portion or an entirety of the surface of the coating area. Furthermore, when the coating is formed on the entire surface of the lithium transition metal compound particle, the surface-modified area may be formed and present on at least a portion or an entirety of the surface of the coating area. The formation location of the surface-modified area as described above may be controlled by adjusting a reaction condition when forming the surface-modified area.

According to an embodiment of the present disclosure, the positive electrode active material may not include a bond (S—P) between an S element and a P element. In this regard, not including the bond (S—P) between the S element and the P element may mean not including an S—P bond formed via an artificial reaction. For example, when lithium phosphate (Li₃PO₄) is used as the coating area, not including the bond (S—P) between the S element and the P element means that the P atom of the coating area does not bind to the S atom of the surface-modified area.

According to an embodiment of the present disclosure, the lithium transition metal composite oxide particle may be at least one selected from the group consisting of a single crystal single-particle, a polycrystalline single-particle, and a secondary particle formed by agglomeration of multiple primary particles. Accordingly, the positive electrode active material may include a single-particle and/or a secondary particle formed via agglomeration of multiple primary particles. The above single crystal single-particle and the polycrystalline single-particle mean that the lithium transition metal composite oxide particle is in a form of a single particle. The single crystal and the polycrystal may be distinguished from each other based on presence of a grain boundary within a single particle. The single crystal single-particle may mean that there are no grains within the single-particle, and the polycrystalline single-particle may mean that there are grains within the single-particle such that multiple crystals form one particle. Furthermore, the secondary particle formed via the agglomeration of the multiple primary particles may include all secondary particle forms formed via the agglomeration of two or more primary particles.

According to an embodiment of the present disclosure, the lithium transition metal composite oxide particle may have an average composition represented by a following Chemical Formula 4. In other words, the lithium transition metal composite oxide may be a lithium transition metal composite oxide of high nickel.

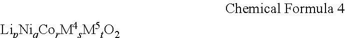

In the Chemical Formula 4, M⁴ is Mn, Al, or a combination thereof, and M⁵ includes at least one selected from the group consisting of Nb, Ta, B, Zr, Cr, and W, and p satisfies 0.8≤p≤1.3, q satisfies 0<q<1, r satisfies 0<r<1, s satifies 0<s<1, t satisfies 0≤t≤0.2, and q+r+s+t=1.

According to an embodiment of the present disclosure, in the Chemical Formula 4, M⁵ may be a doping element that may be contained in the lithium transition metal composite oxide, and may be appropriately selected as needed.

According to an embodiment of the present disclosure, in the Chemical Formula 4, p is a molar ratio of lithium to a transition metal in the lithium transition metal composite oxide. p may be 0.8 or greater, 0.85 or greater, 0.90 or greater, 0.95 or greater, or 1.0 or greater, and may be 1.3 or smaller, 1.25 or smaller, 1.2 or smaller, 1.15 or smaller, 1.1 or smaller, 1.05 or smaller, or 1.03 or smaller.

According to an embodiment of the present disclosure, in the Chemical Formula 4, q, r, s, and t may be mole fractions of nickel (Ni), cobalt (Co), M⁴, and M⁵ among the transition metals, respectively. In a specific example, the q may be a mole fraction of nickel (Ni) among transition metals, and may be 0.8 or greater. Furthermore, q may be smaller than 1.0, 0.99 or smaller, 0.98 or smaller, 0.97 or smaller, 0.96 or smaller, 0.95 or smaller, 0.94 or smaller, 0.93 or smaller, 0.92 or smaller, 0.91 or smaller, 0.90 or smaller, 0.89 or smaller, 0.88 or smaller, 0.87 or smaller, 0.86 or smaller, 0.85 or smaller, 0.84 or smaller, or 0.83 or smaller. Furthermore, the r may be a mole fraction of cobalt (Co) among the transition metals, and may be greater than 0, 0.01 or greater, 0.02 or greater, 0.03 or greater, 0.04 or greater, 0.05 or greater, 0.06 or greater, 0.07 or greater, 0.08 or greater, 0.09 or greater, or 0.10 or greater, and may be smaller than 0.40, 0.30 or smaller, 0.20 or smaller, or 0.10 or smaller. The s is a mole fraction of M4 among transition metals, and may be greater than 0, 0.01 or greater, 0.02 or greater, 0.03 or greater, 0.04 or greater, 0.05 or greater, 0.06 or greater, 0.07 or greater, 0.08 or greater, 0.09 or greater, or 0.10 or greater, and may be smaller than 0.40, 0.30 or smaller, 0.20 or smaller, or 0.10 or smaller. The t is a mole fraction of M5 among transition metals, and may be 0, 0.01 or greater, 0.02 or greater, 0.03 or greater, 0.04 or greater, 0.05 or greater, 0.06 or greater, 0.07 or greater, 0.08 or greater, 0.09 or greater, 0.10 or greater, 0.11 or greater, 0.12 or greater, 0.13 or greater, 0.14 or greater, 0.15 or greater, 0.16 or greater, 0.17 or greater, 0.18 or greater, or 0.19 or greater, and may be smaller than 0.20, 0.19 or smaller, 0.18 or smaller, 0.17 or smaller, 0.16 or smaller, 0.15 or smaller, 0.14 or smaller, 0.13 or smaller, 0.12 or smaller, 0.11 or smaller, 0.10 or smaller, 0.09 or smaller, 0.08 or smaller, 0.07 or smaller, 0.06 or smaller, 0.05 or smaller, 0.04 or smaller, 0.03 or smaller, 0.02 or smaller, or 0.01 or smaller.

According to an embodiment of the present disclosure, the positive electrode active material may have a D₅₀ of 1 μm inclusive to 20 μm inclusive. In a specific example, the positive electrode active material may have a D₅₀ of 1.0 μm or greater, 1.5 μm or greater, 2.0 μm or greater, 2.5 μm or greater, or 3.0 μm or greater, and 20.0 μm or smaller, 19.0 or smaller, 18.0 or smaller, 17.0 or smaller, 16.0 or smaller, 15.0 or smaller, 14.0 or smaller, 13.0 or smaller, 12.0 or smaller, 11.0 or smaller, 10.0 or smaller, 9.0 or smaller, 8.0 or smaller, 7.0 or smaller, or 6.0 μm or smaller. The D₅₀ may mean a particle size at a 50% point of a volume cumulative distribution according to a particle size measured by a laser diffraction particle size analyzer.

According to an embodiment of the present disclosure, the positive electrode active material may have an average particle size of 1 μm inclusive to 20 μm inclusive. In a specific example, the positive electrode active material may have an average particle size of 1.0 μm or greater, 1.5 μm or greater, 2.0 μm or greater, 2.5 μm or greater, or 3.0 μm or greater, and 20.0 μm or smaller, 19.0 or smaller, 18.0 or smaller, 17.0 or smaller, 16.0 or smaller, 15.0 or smaller, 14.0 or smaller, 13.0 or smaller, 12.0 or smaller, 11.0 or smaller, 10.0 or smaller, 9.0 or smaller, 8.0 or smaller, 7.0 or smaller, or 6.0 μm or smaller. The above average particle size may mean the average particle size according to the arithmetic mean of particle sizes measured based on the major diameters of particles identified from images using a scanning electron microscope.

The method for satisfying each of the components of the positive electrode active material described above is not limited. According to an embodiment of the present disclosure, the positive electrode active material may be prepared by performing heat treatment on the lithium transition metal composite oxide particles in the presence of sulfur(S) powders. In this case, since surface modification is performed in a manner such that sulfur(S) derived from the sulfur(S) powders in a gaseous state is deposited on the surface of the lithium transition metal composite oxide particle. Thus, a very uniform and thin surface-modified area may be formed.

According to an embodiment of the present disclosure, a mixture of lithium transition metal composite oxide particles and the sulfur powders may be added into a crucible and the heat treatment may be performed using a furnace. In this regard, the sulfur powders may react with the surface of the lithium transition metal composite oxide particle as it changes into sulfur gas. In the case in which the lithium transition metal composite oxide includes the coating area, the sulfur gas may react with the surface of the lithium transition metal composite oxide particle or the coating area. In the surface-modified area formed in this way, the chemical potentials of the sulfide-based solid electrolyte and the lithium ion are similar to each other, such that a large concentration gradient may not be caused, and excellent compatibility may be imparted to the interface between the positive electrode active material and the sulfide-based solid electrolyte. Furthermore, the surface-modified area itself may protect the positive electrode active material and control the side reactions.

According to an embodiment of the present disclosure, the sulfur powder used in the heat treatment may have a purity of 99.50% or greater, 99.60% or greater, 99.70% or greater, 99.80% or greater, 99.90% or greater, 99.95% or greater, or 99.99% or greater. In this case, the side reaction may be minimized during the heat treatment due to the high purity.

According to an embodiment of the present disclosure, the heat treatment may be performed at a temperature of 150° C. inclusive to 450° C. inclusive. In a specific example, the heat treatment may be performed at a temperature of 150° C. or higher, 160° C. or higher, 170° C. or higher, 180° C. or higher, 190° C. or higher, 200° C. or higher, 210° C. or higher, 220° C. or higher, 230° C. or higher, 240° C. or higher, 250° C. or higher, 260° C. or higher, 270° C. or higher, 280° C. or higher, or 290° C. or higher, and 450° C. or lower, 440° C. or lower, 430° C. or lower, 420° C. or lower, 410° C. or lower, 400° C. or lower, 390° C. or lower, 380° C. or lower, 370° C. or lower, 360° C. or lower, 350° C. or lower, 340° C. or lower, 330° C. or lower, 320° C. or smaller, or 310° C. or smaller. When the heat treatment temperature is controlled to be within the above range, unintended side reactions may be minimized when introducing sulfur(S) to the surface of the lithium transition metal composite oxide to form the surface-modified area.

According to an embodiment of the present disclosure, the heat treatment may be performed for a time of 1 hour or greater, 1 hour and 30 minutes or greater, 2 hours or greater, 2 hours and 30 minutes or greater, 3 hours or greater, or 3 hours and 30 minutes or greater, and, for a time of 10 hours or smaller, 9 hours or smaller, 8 hours or smaller, 7 hours or smaller, 6 hours or smaller, or 5 hours or smaller. When the heat treatment time is controlled to be within the above range, unintended side reactions may be minimized when introducing sulfur(S) to the surface of the lithium transition metal composite oxide to form the surface-modified area.

The positive electrode active material of the present disclosure may improve the performance of the positive electrode active material of the all-solid-state lithium secondary battery including the sulfide-based solid electrolyte via surface modification using sulfur(S). This may reduce the cost compared to using expensive coating materials, and improve productivity by eliminating or minimizing the coating process. In particular, in the lithium secondary battery using a liquid electrolyte, the interface of the positive electrode active material may be controlled via surface modification, such as interfacial SEI control by an electrolyte additive.

### Positive Electrode

The present disclosure provides a positive electrode including the positive electrode active material described above.

According to an embodiment of the present disclosure, the positive electrode may include a positive electrode current collector, and a positive electrode active material layer formed on the positive electrode current collector, wherein the positive electrode active material layer may include the positive electrode active material as described above.

According to an embodiment of the present disclosure, the positive electrode current collector may include a highly conductive metal. A material thereof is not particularly limited as long as the positive electrode current collector is easily adhered to the positive electrode active material layer but is not reactive in a voltage range of the battery. In a specific example, the positive electrode current collector may be made of stainless steel, aluminum, nickel, titanium, calcined carbon, or aluminum or stainless steel surface-treated with carbon, nickel, titanium, silver, etc. Furthermore, the positive electrode current collector may have a thickness of about 3 μm to 500 μm, and may have fine concaveness-convexness on the current collector surface or increase the adhesive strength thereof to the positive electrode active material through surface treatment thereof. Furthermore, the positive electrode current collector may be used in various forms such as a film, a sheet, a foil, a net, a porous body, a foam, a non-woven fabric, etc.

According to an embodiment of the present disclosure, the positive electrode active material layer may optionally include a solid electrolyte, a binder, and a conductive material together with the positive electrode active material. In this regard, the positive electrode active material may be contained in a range of 80 wt % to 99 wt % based on a total weight of the positive electrode active material layer. Within this range, excellent capacity characteristics and improved energy density may be exhibited.

According to an embodiment of the present disclosure, when the positive electrode active material layer includes the solid electrolyte, the solid electrolyte may be the same as or different from the solid electrolyte contained in the solid electrolyte layer of the all-solid-state battery. In a specific example, the solid electrolyte contained in the positive electrode active material layer may be an argyrodite-type sulfide-based solid electrolyte.

According to an embodiment of the present disclosure, when the positive electrode active material layer includes the binder, the binder is a component that assists in bonding between components of the positive electrode active material layer, such as the positive electrode active material, the solid electrolyte, and the conductive material. The binder may be at least one selected from the group consisting of polyvinylidene fluoride-hexafluoropropylene copolymer (PVDF-co-HEP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylic acid, ethylene-propylene-diene monomer (EPDM), sulfonated EPDM, styrene butylene rubber (SBR), and fluororubber.

According to an embodiment of the present disclosure, when the positive electrode active material layer includes the conductive material, the conductive material may be conductive without causing a chemical change in the all-solid-state lithium secondary battery. In a specific example, the conductive material may be at least one selected from the group consisting of graphite such as natural graphite or artificial graphite; carbon black such as acetylene black, Ketjen black, channel black, furnace black, lamp black, thermal black; conductive fibers such as carbon fibers or metal fibers; fluorinated carbon; metal powder such as aluminum or nickel powder; conductive whiskers such as zinc oxide or potassium titanate; conductive metal oxide such as titanium oxide; conductive materials such as polyphenylene derivatives, or the like.

### Lithium Secondary Battery

The present disclosure provides a lithium secondary battery including the positive electrode as described above.

According to an embodiment of the present disclosure, the lithium secondary battery may be an all-solid-state lithium secondary battery. In a specific example, the lithium secondary battery may include a positive electrode 10, a negative electrode 20, and a solid electrolyte layer 30 interposed between the positive electrode 10 and the negative electrode 20.

According to an embodiment of the present disclosure, the negative electrode may include a negative electrode current collector and a negative electrode active material layer formed on at least one surface of the negative electrode current collector.

According to an embodiment of the present disclosure, the negative electrode current collector may include a metal having high conductivity. A material of the negative electrode current collector is not particularly limited as long as the negative electrode active material layer is easily adhered to the negative electrode current collector, and the negative electrode current collector is not reactive in the voltage range of the battery. In a specific example, the negative electrode current collector may include copper, stainless steel, aluminum, nickel, titanium, calcined carbon, or aluminum or stainless steel surface-treated with carbon, nickel, titanium, silver, etc. Furthermore, the negative electrode current collector may have a thickness of about 3 μm to 500 μm, and may have fine concaveness-convexness on the surface of the current collector or increase the adhesion thereof to the negative electrode active material via surface treatment thereon. Furthermore, the negative electrode current collector may be used in various forms such as a film, a sheet, a foil, a net, a porous body, a foam, a non-woven fabric, and the like.

According to an embodiment of the present disclosure, the negative electrode active material layer may optionally include a solid electrolyte, a binder, and a conductive material together with the negative electrode active material.

According to an embodiment of the present disclosure, a compound capable of reversible intercalation and deintercalation of lithium may be used as the negative electrode active material. In a specific example, the negative electrode active material layer may include at least one negative electrode active material selected from the group consisting of a carbon-based negative electrode active material, a silicon-based negative electrode active material, and a lithium metal negative electrode active material. More specifically, the negative electrode active material may include carbon-based negative electrode active materials such as artificial graphite, natural graphite, graphitized carbon fiber, and amorphous carbon; silicon-based negative electrode active materials Si, Si alloy, and SiOₓ (0<x<2); metal compounds capable of alloying with lithium such as Al, Sn, lead (Pb), zinc (Zn), bismuth (Bi), indium (In), magnesium (Mg), gallium (Ga), cadmium (Cd), silicon (Si) alloy, Sn alloy, or Al alloy; metal oxides capable of doping and dedoping lithium, such as SnO₂, vanadium oxide, and lithium vanadium oxide; or composites including the metal compounds and carbonaceous materials, such as Si—C composites or Sn—C composites (where C is carbon), and/or a mixture of one or two or more thereof. Furthermore, a lithium metal thin film made of a lithium metal negative electrode active material may be used as the negative electrode active material. Furthermore, both low crystalline carbon and high crystalline carbon may be used as the carbon-based negative electrode active material. The low crystalline carbons include soft carbon and hard carbon, and the high crystalline carbons include amorphous, plate-like, spherical, or fiber-like natural or artificial graphite, Kish graphite, pyrolytic carbon, mesophase pitch-based carbon fibers, meso-carbon microbeads, mesophase pitches, and high-temperature fired carbons such as petroleum or coal tar pitch derived cokes. The negative electrode active material may be contained in a range of 80 wt % to 99 wt % based on the total weight of the negative electrode active material layer. Within this range, excellent capacity characteristics and improved energy density may be exhibited.

According to an embodiment of the present disclosure, when the negative electrode active material layer includes the solid electrolyte, the solid electrolyte may be the same as or different from the solid electrolyte contained in the solid electrolyte layer of the all-solid-state battery. In a specific example, the solid electrolyte contained in the negative electrode active material layer may be an argyrodite-type sulfide-based solid electrolyte.

According to an embodiment of the present disclosure, when the negative electrode active material layer includes the binder, the binder is a component that assists in bonding between the components of the negative electrode active material layer, such as the positive electrode active material, the solid electrolyte, and the conductive material. The binder may be at least one selected from the group consisting of polyvinylidene fluoride-hexafluoropropylene copolymer (PVDF-co-HEP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylic acid, ethylene-propylene-diene monomer (EPDM), sulfonated EPDM, styrene butylene rubber (SBR), and fluororubber.

According to an embodiment of the present disclosure, when the negative electrode active material layer includes the conductive material, the conductive material may be conductive without causing a chemical change in the all-solid-state lithium secondary battery. In a specific example, the conductive material may be at least one selected from the group consisting of graphite such as natural graphite or artificial graphite; carbon black such as acetylene black, Ketjen black, channel black, furnace black, lamp black, thermal black; conductive fibers such as carbon fibers or metal fibers; fluorinated carbon; metal powders such as aluminum or nickel powder; conductive whiskers such as zinc oxide or potassium titanate; conductive metal oxides such as titanium oxide; conductive materials such as polyphenylene derivatives, or the like.

According to an embodiment of the present disclosure, the solid electrolyte layer may include the sulfide-based solid electrolyte, and may optionally include the binder together with the solid electrolyte.

According to an embodiment of the present disclosure, the solid electrolyte of the solid electrolyte layer may be the same as or different from the solid electrolyte that may be contained in the negative electrode active material layer and/or the positive electrode active material layer as described above. In a specific example, the solid electrolyte contained in the solid electrolyte layer may be at least one selected from the group consisting of a sulfide-based solid electrolyte, an oxide-based solid electrolyte, a chloride-based solid electrolyte, and a polymer solid electrolyte. In a more specific example, the solid electrolyte may be an argyrodite-type sulfide-based solid electrolyte.

According to an embodiment of the present disclosure, when the solid electrolyte layer includes the binder, the binder is a component that assists in bonding between the solid electrolytes, and may be at least one selected from the group consisting of polyvinylidene fluoride-hexafluoropropylene copolymer (PVDF-co-HEP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylic acid, ethylene-propylene-diene monomer (EPDM), sulfonated EPDM, styrene butylene rubber (SBR), and fluororubber.

The lithium secondary battery including the positive electrode active material according to the present disclosure stably exhibits excellent capacity characteristics, output characteristics, and life characteristics, and therefore, is particularly useful in the electric vehicle field, such as a hybrid electric vehicle (HEV) and an electric vehicle (EV).

An outer appearance of the lithium secondary battery of the present disclosure is not particularly limited, but may have a cylindrical shape, a square pillar shape, a pouch shape, or a coin shape. Furthermore, the lithium secondary battery may be used as a unit cell in a medium-or large-sized battery module including a plurality of battery cells. Accordingly, the present disclosure provides a battery module including the lithium secondary battery as a unit cell and a battery pack including the same.

According to an embodiment of the present disclosure, the battery module or the battery pack may be used as a power source for one or more medium to large-sized devices including a power tool; an electric vehicle including an electric vehicle (EV), a hybrid electric vehicle, and a plug-in hybrid electric vehicle (PHEV); or the power storage system.

Hereinafter, the present disclosure is described in detail based on Examples so that those having ordinary skill in the art may easily practice the present disclosure. However, the present disclosure may be implemented in various different forms and is not limited to the Examples described herein.

### Examples and Comparative Examples

### Present Example 1

Sulfur (99.998% purity) was pulverized to prepare fine sulfur powders. The prepared sulfur powders and the lithium transition metal composite oxide having a composition of LiNi_{0.8}CO_{0.1}Mn_{0.1}O₂ and a D₅₀ of 3 μm in a secondary particle form were mixed with each other using a mixer mill (Retsch, MM400) at about 30 Hz for about 3 minutes to obtain a mixture. In this regard, a content of the sulfur powders was 0.05 parts by weight with respect to 100 parts by weight of the lithium transition metal composite oxide.

The above mixture was placed into a sealed tube under an argon atmosphere and heat-treated at about 300° C. for about 4 hours to prepare a positive electrode active material having the surface-modified area formed on the surface of the particle.

### Present Example 2

The positive electrode active material having the surface-modified area formed on the surface of the particle was prepared in the same manner as in the Present Example 1 except that when preparing the mixture in the Present Example 2, the content of the sulfur powders was 0.07 parts by weight instead of 0.05 parts by weight with respect to 100 parts by weight of the lithium transition metal composite oxide.

### Present Example 3

The positive electrode active material having the surface-modified area formed on the surface of the particle was prepared in the same manner as in the Present Example 1 except that when preparing the mixture in the Present Example 3, the content of the sulfur powders was 0.10 parts by weight instead of 0.05 parts by weight with respect to 100 parts by weight of the lithium transition metal composite oxide.

### Present Example 4

The positive electrode active material having the surface-modified area formed on the surface of the particle was prepared in the same manner as in the Present Example 1 except that when preparing the mixture in the Present Example 4, the content of the sulfur powders was 0.30 parts by weight instead of 0.05 parts by weight with respect to 100 parts by weight of the lithium transition metal composite oxide.

### Present Example 5

The positive electrode active material having the surface-modified area formed on the surface of the particle was prepared in the same manner as in the Present Example 1 except that when preparing the mixture in the Present Example 5, the content of the sulfur powders was 0.50 parts by weight instead of 0.05 parts by weight with respect to 100 parts by weight of the lithium transition metal composite oxide.

### Present Example 6

The positive electrode active material having the surface-modified area formed on the surface of the particle was prepared in the same manner as in the Present Example 1 except that when preparing the mixture in the Present Example 6, the content of the sulfur powders was 0.70 parts by weight instead of 0.05 parts by weight with respect to 100 parts by weight of the lithium transition metal composite oxide.

### Present Example 7

The positive electrode active material having the surface-modified area formed on the surface of the particle was prepared in the same manner as in the Present Example 1 except that when preparing the mixture in the Present Example 7, the content of the sulfur powders was 1.00 parts by weight instead of 0.05 parts by weight with respect to 100 parts by weight of the lithium transition metal composite oxide.

### Present Example 8

The positive electrode active material having the surface-modified area formed on the surface of the particle was prepared in the same manner as in the Present Example 1 except that when preparing the mixture in the Present Example 8, the content of the sulfur powders was 1.50 parts by weight instead of 0.05 parts by weight with respect to 100 parts by weight of the lithium transition metal composite oxide.

### Present Example 9

A coating solution was prepared by dissolving 0.12 parts by weight of lithium ethoxide (Kojundo, CH3CH2Oli 99.9%) and 0.125 parts by weight of polyphosphoric acid (Aldrich, H3PO4 115%) in about 30 ml of reagent alcohol (CH3CH2OH) solvent so that a content of Li₃PO₄ was 0.15 parts by weight based on 100 parts by weight of the lithium transition metal composite oxide. About 3 g of lithium transition metal composite oxide having a composition of LiNi_{0.8}CO_{0.1}Mn_{0.1}O₂ and a D₅₀ of 3 μm in a secondary particle form was added to the coating solution. Thereafter, the mixture was subjected to stirring at about 70° C. and the solvent was evaporated. Then, the residual solvent was completely evaporated in a vacuum oven, and heat treatment was performed thereon at about 400° C. for about 1 hour to obtain an intermediate in which Li₃PO₄ was coated on the surface of the lithium transition metal composite oxide particle.

Then, solid sulfur (purity 99.998%) was pulverized to prepare fine sulfur powders. The prepared sulfur powders and the intermediate were mixed with each other using a mixer mill (Retsch, MM400) at about 30 Hz for about 3 minutes to obtain a mixture. In this regard, a content of the sulfur powders was 0.10 weight part based on 100 weight parts of the lithium transition metal composite oxide.

The mixture was placed into a sealed tube under an argon atmosphere and heat-treated at about 300° C. for about 4 hours to prepare a positive electrode active material with a coating and a surface-modified area formed on the surface of the particle.

### Present Example 10

The positive electrode active material having the coating and the surface-modified area formed on the surface of the particle was prepared in the same manner as in the Present Example 9 except that when preparing the mixture in the Present Example 9, the content of the sulfur powders was 1.50 parts by weight instead of 0.10 parts by weight with respect to 100 parts by weight of the lithium transition metal composite oxide.

### Comparative Example 1

The lithium transition metal composite oxide having a composition of LiNi_{0.8}CO_{0.1}Mn_{0.1}O₂ and a D₅₀ of 3 μm in a secondary particle form was directly used as the positive electrode active material.

### Comparative Example 2

The intermediate prepared in Present Example 2 was directly used as the positive electrode active material.

### Experimental Example 1: ICP-OES Analysis

ICP-OES analysis was performed on the positive electrode active material prepared in each of Present Examples 3 and 8-10 and Comparative Example 1, under the conditions of temperature 18° C. and humidity 38% according to the KS M 2005 general rule for mass spectrometry. Thus, a content of each element, the increase in the content of sulfur(S) element compared to Comparative Example 1, and the content of sulfur(S) remaining in the positive electrode active material compared to the added amount of sulfur (S) are shown in Table 1 below.

TABLE 1

| | | Present | Present | Present | Present | Comparative |
|---|---|---|---|---|---|---|
| | | Example | Example | Example | Example | Example |
| Examples | | 3 | 8 | 9 | 10 | 1 |
| Element | (Wavelength) | Content (mg/kg) | | | | |
| Li | (670.783 | 67310.22 | 65726.26 | 67321.57 | 66944.94 | 66175.21 |
| | nm) | | | | | |
| Ni | (231.604 | 503022.31 | 489588.84 | 497401.34 | 496609.71 | 488957.01 |
| | nm) | | | | | |
| Co | (238.892 | 88099.21 | 86379.76 | 87751.53 | 88245.60 | 86359.04 |
| | nm) | | | | | |
| Mn | (257.610 | 15724.97 | 15878.22 | 15405.70 | 16384.66 | 15214.63 |
| | nm) | | | | | |
| P | (213.618 | 6.03 | 12.94 | 423.61 | 388.62 | —¹⁾ |
| | nm) | | | | | |
| S | (181.972 | 977.50 | 3633.11 | 1074.43 | 3325.98 | 644.66 |
| | nm) | | | | | |
| Increase in content of | | 332.84 | 2988.46 | 429.77 | 2681.32 | 0.00 |
| sulfur (S) element | | | | | | |
| Content of | (Wt %) | 33.3 | 19.9 | 43.0 | 17.9 | 0 |
| remaining | | | | | | |
| sulfur (S) | | | | | | |
| compared to | | | | | | |
| added amount | | | | | | |
| of sulfur | | | | | | |

¹⁾Below Quantitation Limit

As shown in Table 1 above, it was identified that when forming the surface-modified area using sulfur powders, the sulfur(S) component was detected. However, when it is assumed that the surface of the lithium transition metal composite oxide particle is coated with a single substance of sulfur(S), the coating amount should increase according to increase in the amount of sulfur(S) as added, However, it was identified that there was a significant difference in the content of sulfur(S) remaining in the positive electrode active material from the content of sulfur(S) as added. Thus, it is expected that this is because when forming the surface-modified area, sulfur(S) does not form a coating layer made of the single substance, but forms the surface-modified area via reaction with the surface of the lithium transition metal composite oxide particle, and no solvent is used, such that an entirety of sulfur(S) does not react with lithium transition metal composite oxide during the heat treatment process, but the sulfur is partially sublimated and lost.

From these results, it was identified that there is a limit to the reaction with the surface of lithium transition metal composite oxide particles as the content of sulfur(S) increases, and the percentage of the sulfur(S) as lost increases, such that the content of sulfur(S) that actually forms the surface-modified area reaches a saturation state at a certain level.

Furthermore, from the results of Present Examples 3 and 8 to 10, it was identified that the presence or absence of the coating on the surface of lithium transition metal composite oxide particles does not affect a formation of the surface-modified area.

### Reference Experimental Example 1: TOF-SIMS Analysis

In order to clarify that the presence or absence of the coating on the surface of the lithium transition metal composite oxide particles does not affect a formation of the surface-modified area as identified in Experimental Example 1 above, the surface modification was directly performed not on the lithium transition metal composite oxide but on Li₃PO₄ (Reference Example 1).

Specifically, solid sulfur (purity 99.998%) was pulverized to prepare fine sulfur powders. The prepared sulfur powders and Li₃PO₄ were mixed with each other using a mixer mill (Retsch, MM400) at about 30 Hz for about 3 minutes to obtain a mixture. In this regard, the content of the sulfur powders was 0.10 parts by weight (Reference Example 2), 1.00 parts by weight (Reference Example 3), and 2.00 parts by weight (Reference Example 4) with respect to 100 parts by weight of the Li₃PO₄.

The mixture was placed in a sealed tube under an argon atmosphere and heat-treated at about 300° C. for about 4 hours to form a sulfur(S) coating layer on the Li₃PO₄ surface.

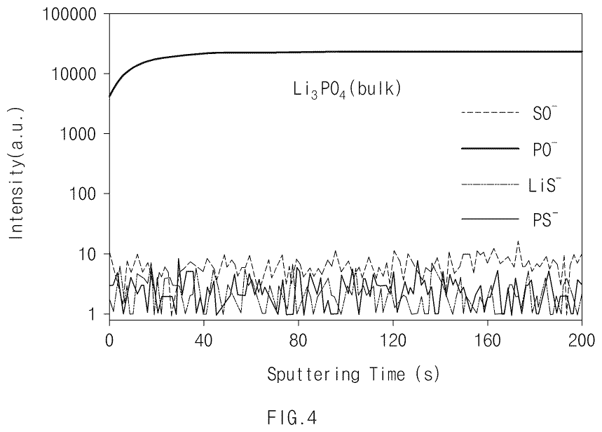

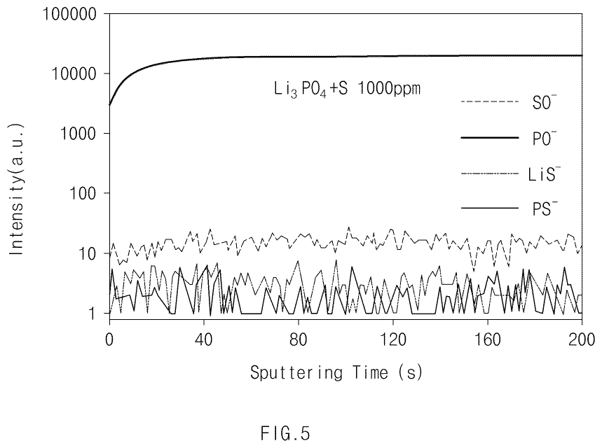

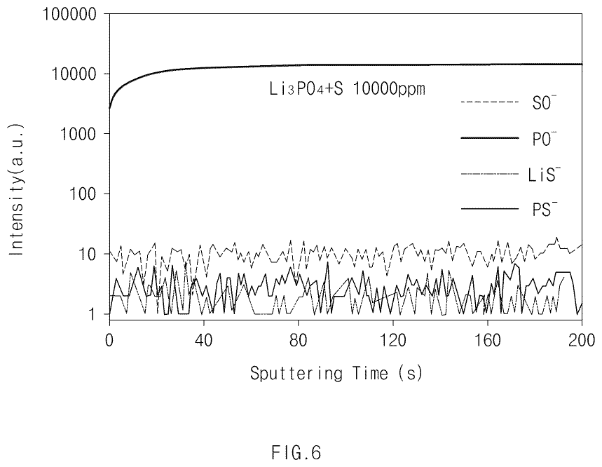

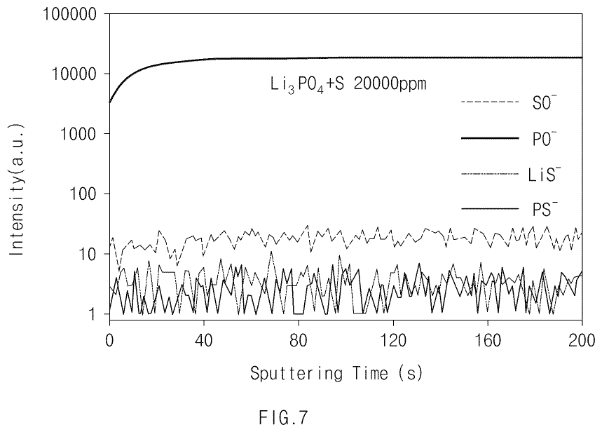

TOF-SIMS analysis was performed on the Li₃PO₄ and the Li₃PO₄ including the sulfur(S) coating layer as prepared in the above Reference Examples 1-4 using TOFSIMS.5 of ION-TOF (Germany) under the analysis conditions of Bil⁺, 30 keV, and 1 pA, and the intensities of SO⁻, PO⁻, LiS⁻, and PS⁻ ions were measured based on a sputtering time while sputtering from the surface of each material, and the results are shown in FIG. 4 (Reference Example 1), FIG. 5 (Reference Example 2), FIG. 6 (Reference Example 3), and FIG. 7 (Reference Example 4).

As may be identified in FIGS. 4 to 7, it was identified that a difference between the intensity of each of SO⁻, PO⁻, LiS⁻, and PS⁻ ions in Reference Examples 2 to 4 in which the sulfur(S) coating layer was formed and the intensity thereof in Reference Example 1 was insignificant. From these results, it was identified that even when the sulfur(S) coating layer was formed on Li₃PO₄, the sulfur did not react with Li₃PO₄. This is expected to be due to the fact that the heat treatment using sulfur(S) powders was performed at a relatively low temperature, so that sulfur(S) could not break the P—O bond of Li₃PO₄ and thus could not form the P—S bond.

### Reference Experimental Example 2: XRD Analysis

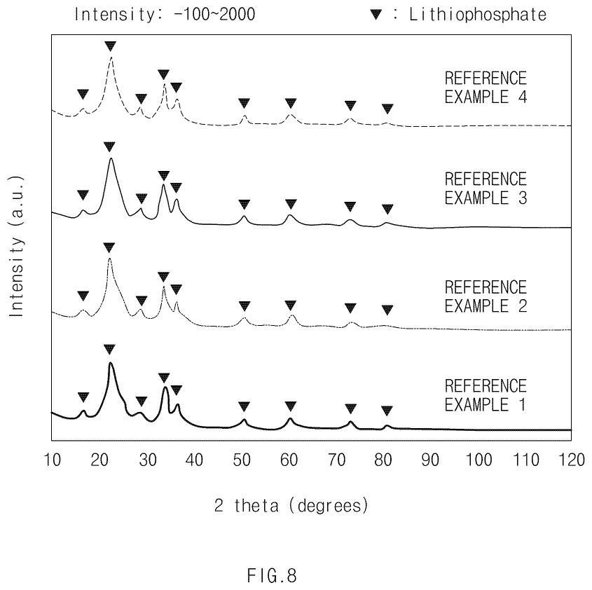

In addition to the above Reference Experimental Example 1, XRD analysis was performed on Reference Examples 1˜4 using Empyrean from Malvern Panalytical, and the results are shown in FIG. 8.

As may be identified in FIG. 8, the peak related to the sulfur(S) was not identified, which is the same result as the analysis result of Reference Experimental Example 1.

### Experimental Example 2: XPS Analysis 1

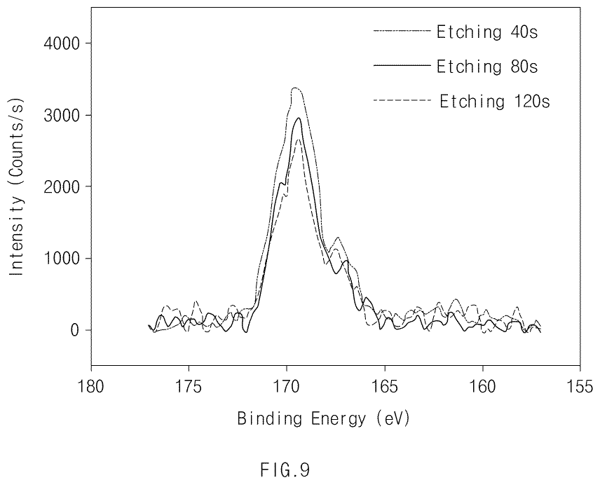

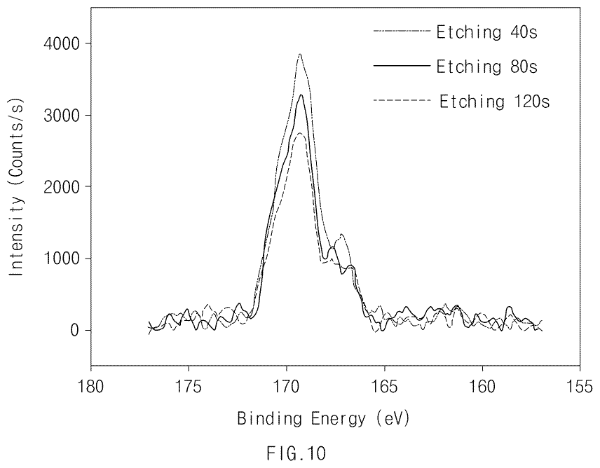

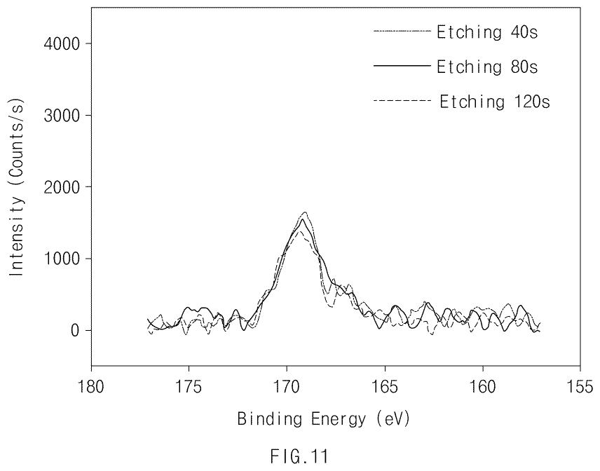

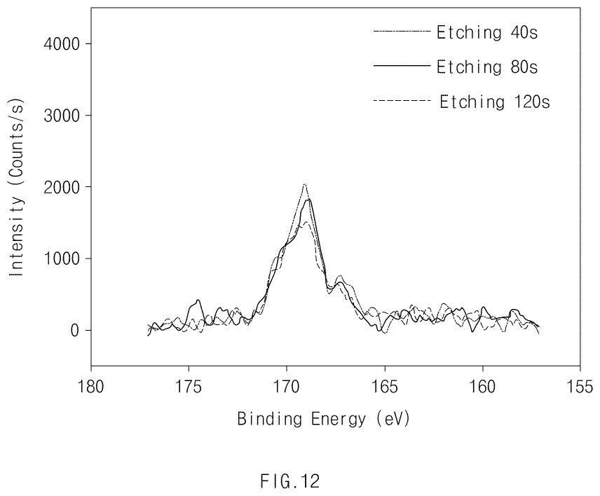

XPS analysis was performed on the positive electrode active material prepared in each of the Present Examples 3 and 9 and Comparative Examples 1 and 2 using Thermo Scientific's K−Alpha+ under the conditions of Al ka (1486.6 eV) 12 KeV/6 mA, Beam size: 400 μm. The results are shown in FIG. 9 (Present Example 3), FIG. 10 (Present Example 9), FIG. 11 (Comparative Example 1), and FIG. 12 (Comparative Example 2). The intensities of SO₃²⁻ and SO₄²⁻ and the ratio (SO₃²⁻/SO₄²⁻) there between are shown in Table 2 below.

TABLE 2

| | binding | Present | Present | Comparative | Comparative |
|---|---|---|---|---|---|
| Examples | energy | Example 3 | Example 9 | Example 1 | Example 2 |
| SO₃²⁻ | 167.4 eV | 1,100 | 900 | 500 | 500 |
| SO₄²⁻ | 168.9 eV | 2,700 | 2,700 | 1,300 | 2,000 |

| | | | | |
|---|---|---|---|---|
| SO₃²⁻/SO₄²⁻ | 0.41 | 0.33 | 0.41 | 0.25 |

As shown in Table 2 above, it was identified that the positive electrode active materials prepared in each of Present Examples 3 and 9 of the present disclosure had increased intensities of SO₃²⁻ and SO₄²⁻ due to the surface-modified area, compared to the positive electrode active materials prepared in each of Comparative Examples 1 and 2. From these results, it was identified that the positive electrode active material prepared in each of Present Examples of the present disclosure included the compounds represented by the Chemical Formulas 1 and 2.

### Experimental Example 3: TOF-SIMS Analysis 1

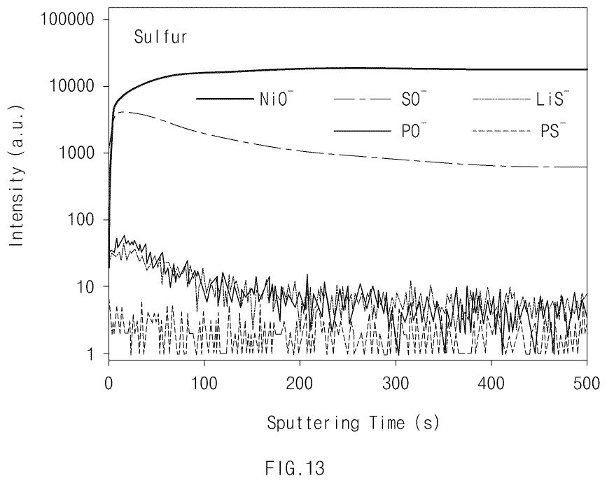

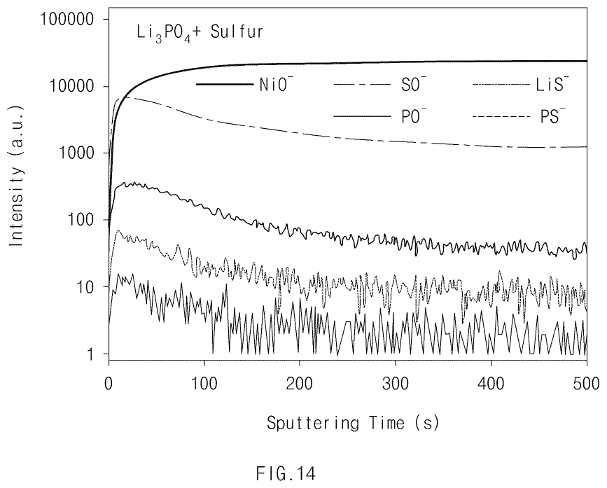

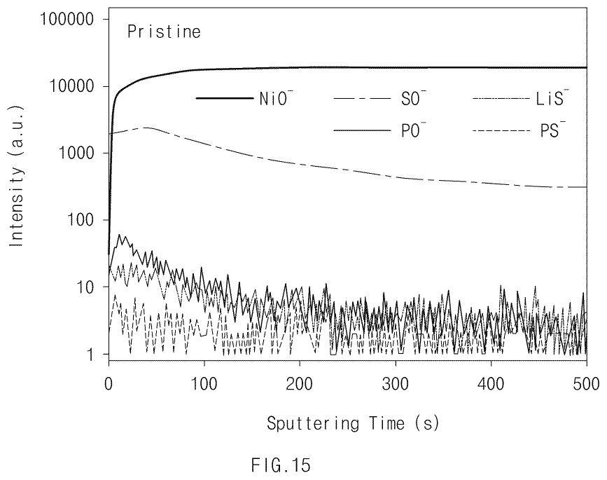

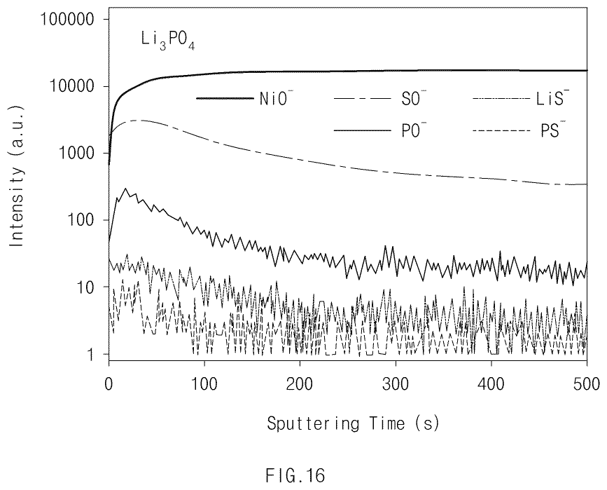

TOF-SIMS analysis was performed on the positive electrode active material prepared in each of Present Examples 3 and 9 and Comparative Examples 1 and 2 in the same manner as in Experimental Example 1. The intensity of each of Nio⁻, SO⁻, PO⁻, Lis⁻, and PS⁻ ions was measured based on a sputtering time while sputtering from the surface of each positive electrode active material. The results are shown in FIG. 13 (Present Example 3), FIG. 14 (Present Example 9), FIG. 15 (Comparative Example 1), and FIG. 16 (Comparative Example 2). Furthermore, the intensity of each of S⁻, HS⁻, SO⁻, SO₂⁻, and SO₃⁻ ions is calculated in a following manner. Then, Present Example 3 is indexed relative to Comparative Example 1, and Present Example 9 is indexed relative to Comparative Example 2, and the ratio between SO₃⁻ and SO₂⁻ (SO₃⁻/SO₂⁻), and the ratio between SO⁻ and SO₃⁻ (SO⁻/SO₃⁻) are shown in Table 3 below.

TABLE 3

| | | Present | Present | Comparative | Comparative |
|---|---|---|---|---|---|
| Examples | | Example 3 | Example 9 | Example 1 | Example 2 |
| S⁻ | Intensity | 33,763 | 43,061 | 20,696 | 25,692 |
| | Indexing (%) | 177 | 241 | 100 | 100 |
| HS⁻ | Intensity | 5,952 | 5,641 | 4,119 | 4,422 |
| | Indexing (%) | 157 | 183 | 100 | 100 |
| SO⁻ | Intensity | 38,753 | 35,173 | 16,156 | 21,627 |
| | Indexing (%) | 260 | 232 | 100 | 100 |
| SO₂⁻ | Intensity | 149,805 | 111,066 | 58,437 | 77,529 |
| | Indexing (%) | 278 | 202 | 100 | 100 |
| SO₃⁻ | Intensity | 111,066 | 61,963 | 36,653 | 45,550 |
| | Indexing (%) | 277 | 192 | 100 | 100 |

| | | | | |
|---|---|---|---|---|
| SO₃⁻/SO₂⁻ | 0.62 | 0.56 | 0.63 | 0.59 |
| SO⁻/SO₃⁻ | 0.41 | 0.57 | 0.44 | 0.47 |

As may be identified in FIG. 13-FIG. 16, in Present Examples 3 and 9 in which the surface-modified area was formed using sulfur(S), SO⁻ and LiS⁻ ions were detected on the surface at high intensities, and in Present Example 9 and Comparative Example 2, which included the coating of Li₃PO₄, PO⁻ ions were detected at high intensities. However, as identified in the Reference Experimental Example 1 above, PS⁻ ions were not detected in Present Example 9.

Furthermore, as shown in Table 3, it was identified that in Present Examples 3 and 9 in which the surface-modified area was formed using sulfur(S), each of the intensities of S⁻, HS⁻, SO⁻, SO₂⁻, and SO₃⁻ ions were significantly increased compared to Comparative Examples 1 and 2.

### Experimental Example 4: TOF-SIMS Analysis 2

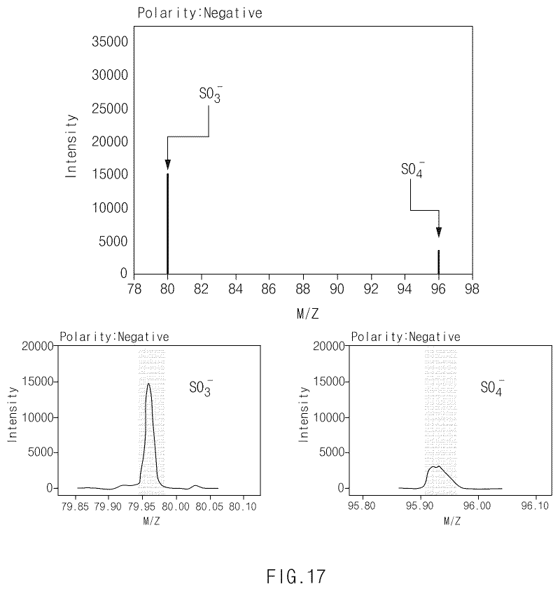

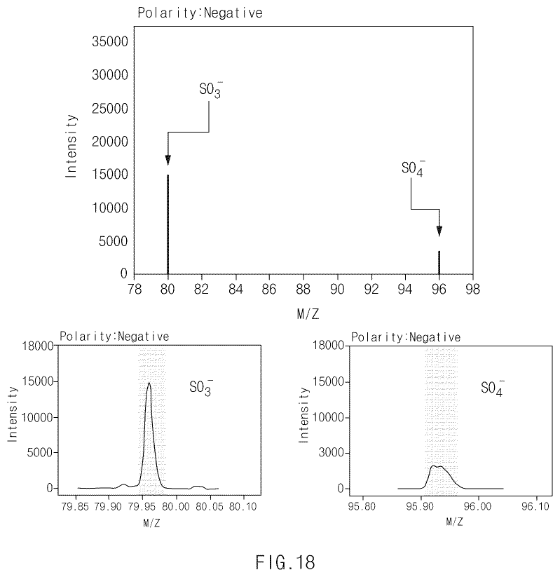

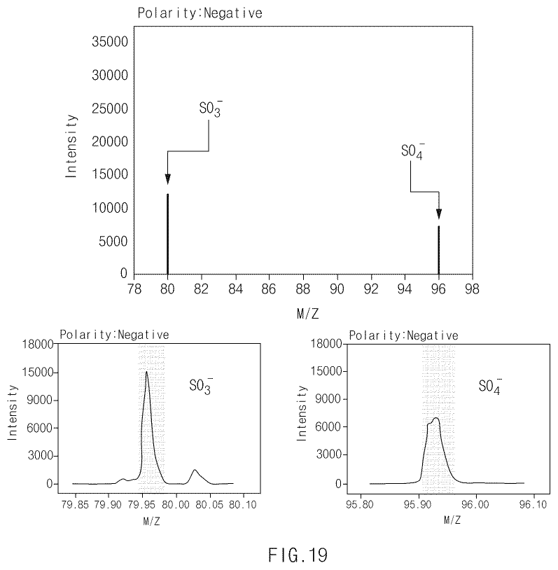

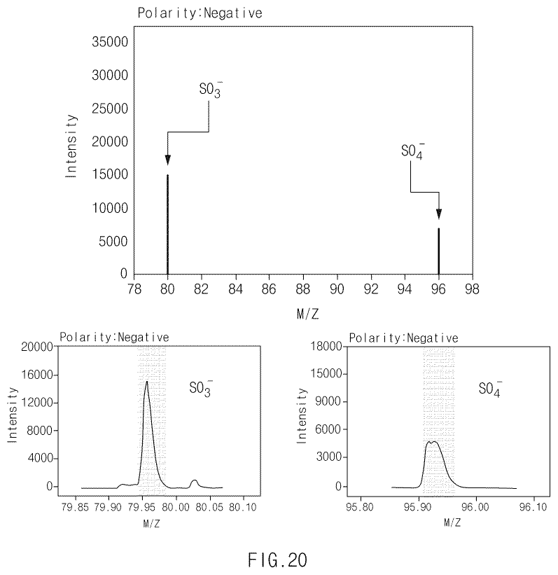

TOF-SIMS analysis was performed on the positive electrode active material prepared in each of Present Examples 3 and 9 and Comparative Examples 1 and 2 using TOFSIMS.5 of ION-TOF (Germany) under the analysis conditions of Bil+, 30 keV, and 1 pA. The results are shown in FIG. 17 (Present Example 3), FIG. 18 (Present Example 9), FIG. 19 (Comparative Example 1), and FIG. 20 (Comparative Example 2). The mass-to-charge ratio (Peak M/Z, ±0.03) at which the peak of each of SO₃⁻ and SO₄⁻ appears, the intensity of the corresponding peak area, and a ratio of the peak area size of SO₄⁻ to the peak area size of SO₃⁻ are shown in Table 4 below.

TABLE 4

| | | Present | Present | Comparative | Comparative |
|---|---|---|---|---|---|
| Examples | | Example 3 | Example 9 | Example 1 | Example 2 |
| SO₃⁻ | Peak M/Z | 79.96 | 79.96 | 79.96 | 79.96 |
| | (±0.03) | | | | |
| | Areal | 99,060 | 44,758 | 36,247 | 48,388 |
| | Intensity | | | | |
| | Area ratio | 1.000 | 1.000 | 1.000 | 1.000 |
| SO₄⁻ | Peak M/Z | 95.93 | 95.93 | 95.93 | 95.93 |
| | (±0.03) | | | | |
| | Areal | 42,795 | 20,996 | 43,507 | 42,536 |
| | Intensity | | | | |
| | Area ratio | 0.432 | 0.469 | 1.200 | 0.879 |

As shown in Table 4 above, it was identified that the positive electrode active material prepared in each of Present Examples 3 and 9 of the present disclosure had a significantly reduced ratio of the peak area size of SO₄⁻ to the peak area size of SO₃⁻ compared to the positive electrode active material prepared in each of Comparative Examples 1 and 2. From this fact, it was identified that when forming the surface-modified area using sulfur(S), SO₃⁻ was formed in a more dominant manner than SO₄″ was.

### Experimental Example 5: XPS Depth Analysis

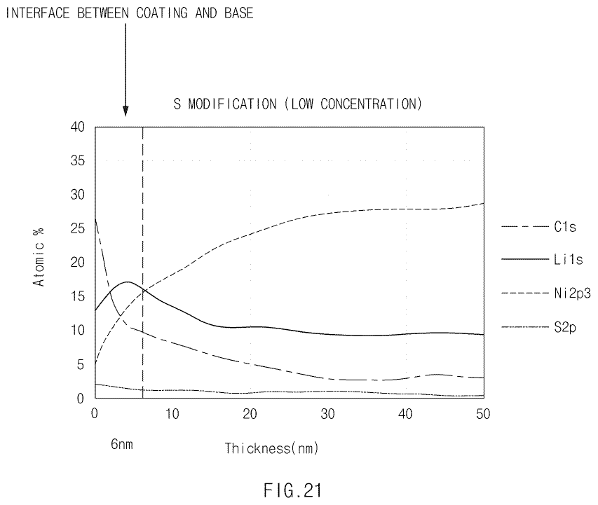

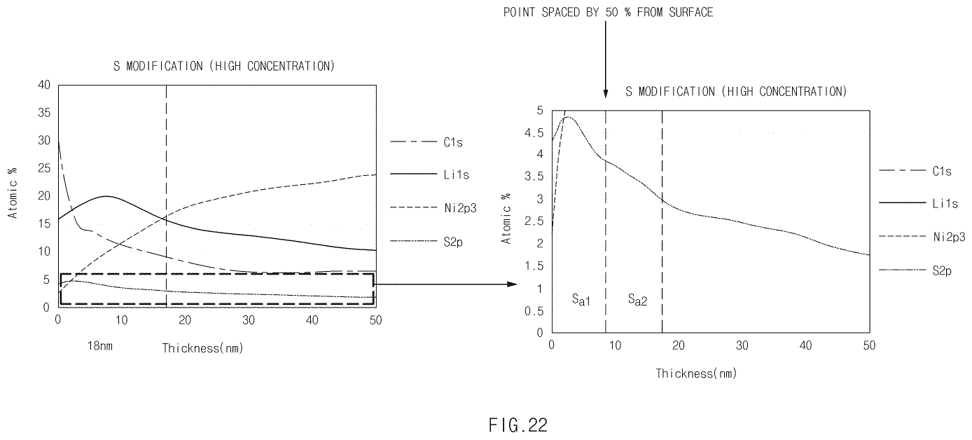

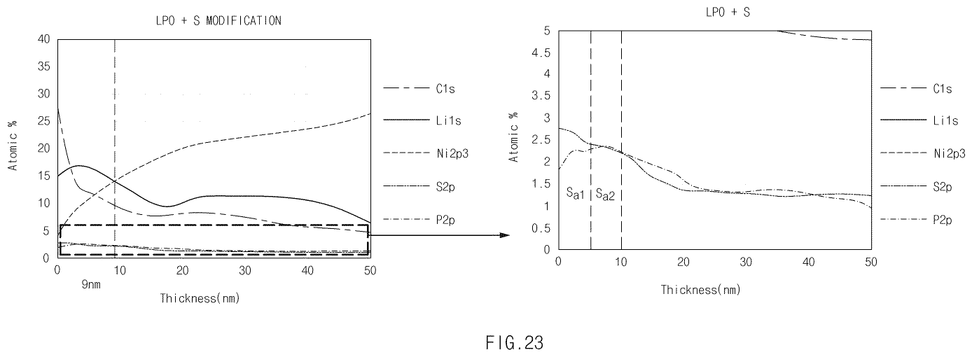

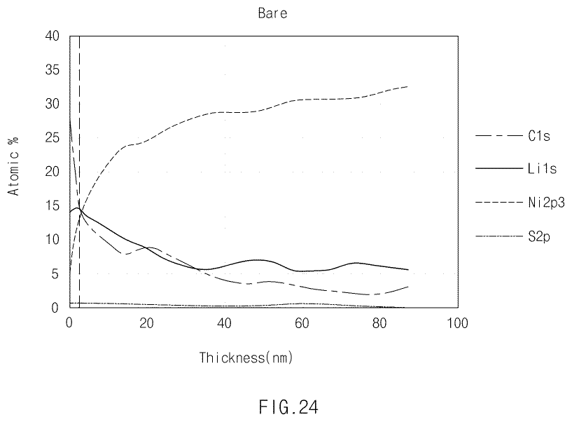

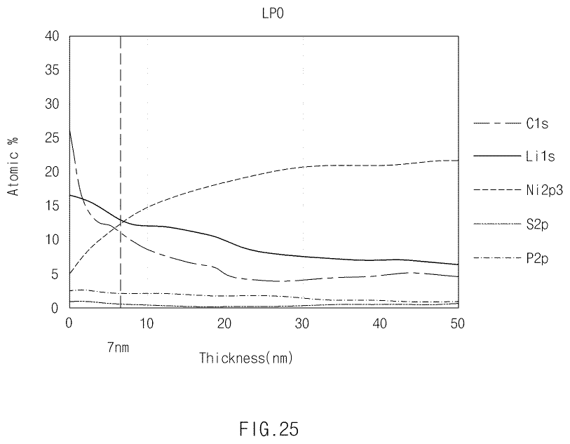

XPS depth analysis was performed on the positive electrode active material prepared in each of Present Examples 3, 8, and 9 and Comparative Examples 1 and 2, using Thermo Scientific's K−Alpha+ under the conditions of Sputter ion gun (Ar+): 1 keV, analysis conditions Al ka (1486.6 eV) 12 KeV/6 mA, Beam size: 400 μm. The results are shown in FIG. 21 (Present Example 3), FIG. 22 (Present Example 8), FIG. 23 (Present Example 9), FIG. 24 (Comparative Example 1), and FIG. 25 (Comparative Example 2).

As may be identified in FIGS. 21-25, it was identified that in Present Examples 3, 8, and 9 where the surface-modified area was formed using sulfur(S), sulfur(S) formed a reaction product at a shallow depth from the surface. In particular, a distance between the outermost surface (OSM) of the positive electrode active material including the surface-modified area and an interface (ICP) between the surface-modified area and the surface of the particle is defined as A. A point in the surface-modified area having a distance from the interface or the OSM being 50% of A is defined as the point (A₅₀). In this case, from FIG. 22 and FIG. 23, it is identified that a concentration of the S element in an area (OSM-A₅₀) between the outermost surface (OSM) of the positive electrode active material including the surface-modified area and the point (A₅₀) as identified by XPS analysis is higher than a concentration of the S element in an area (A₅₀-ICP) between the point (A₅₀) and the interface (ICP) between the surface-modified area and the surface of the particle. Further, it is identified that the concentration of the S element in the area (A₅₀-ICP) between the point (A₅₀) and the interface (ICP) between the surface-modified area and the surface of the particle concentration gradient such that the concentration gradually decreases as the area extends from the point (A₅₀) toward the interface (ICP) between the surface-modified area and the surface of the particle.

### Experimental Example 6: Cell Characteristics Evaluation 1

A positive electrode was manufactured using the positive electrode active material prepared in each of Present Examples 3 and 9 and Comparative Example 1, a solid electrolyte having a composition of Li₆PS₅Cl (where Cl is chloride) and a conductive material at a ratio of 62:37:1, and using an Al foil current collector. A lithium metal foil was used as a negative electrode. Thus, a cell was prepared using a solid electrolyte having a composition of Li₆PS₅Cl as a solid electrolyte layer.

The prepared cell was charged to 4.3 V at a constant current of 0.1 C (coulomb), and then discharged to 2.5 V at 0.1 C in a CC/CV mode at 25° C., and the initial charge capacity and the initial discharge capacity were measured, and the efficiency was calculated. Then, charge and discharge were performed at 0.1 C for up to 3 charge and discharge cycles, 0.2 C for the 4th to 6th charge and discharge cycles, 0.33 C for the 7th to 9th charge and discharge cycles, 0.5 C for the 10th to 12th charge and discharge cycles, 1.0 C for the 13th to 15th charge and discharge cycles, 2.0 C for the 16th to 19th charge and discharge cycles, and 0.5 C for the 20th and subsequent cycles, for up to 100 charge and discharge cycles. The DC resistance at 2 charge and discharge cycles, the rate characteristics at each rate, and the rate characteristics and retention rate at 100 cycles were calculated and shown in Table 5 below.

TABLE 5

| | | | Present | Present | Comparative |
|---|---|---|---|---|---|
| Examples | | | Example 3 | Example 9 | Example 1 |
| One time | Charge | (mAh/g) | 223.3 | 222.0 | 221.5 |
| @0.1 C | capacity | | | | |
| | Discharge | (mAh/g) | 196.8 | 195.9 | 173.1 |
| | capacity | | | | |
| | Efficiency | (%) | 88.1 | 88.2 | 78.1 |
| Two times | DC | (Ω) | 28.9 | 29.3 | 71.1 |
| @0.1 C | resistance | | | | |
| Rate | 0.1 C | (mAh/g) | 188.9 | 190.0 | 158.5 |
| characteristics | 0.2 C | (mAh/g) | 171.5 | 174.9 | 137.5 |
| | 0.33 C | (mAh/g) | 158.1 | 161.3 | 123.8 |
| | 0.5 C | (mAh/g) | 144.7 | 149.2 | 111.4 |
| | 1.0 C | (mAh/g) | 120.2 | 128.0 | 85.5 |
| | 2.0 C | (mAh/g) | 86.5 | 100.4 | 43.8 |
| | Retention rate | (%) | 86.0 | 84.4 | 81.9 |
| | @100 Cy | | | | |

As shown in Table 5 above, the all-solid-state lithium secondary battery including the positive electrode active material prepared in each of Present Examples 3 and 9 of the present disclosure was identified to have significantly improved discharge capacity, efficiency, DC resistance, rate characteristics, and capacity retention rate.

### Experimental Example 7: Cell Characteristics Evaluation 2

Using the positive electrode active material prepared in each of Present Examples 1, 2, and 4-8 above, a cell was prepared in the same manner as in Experimental Example 6.

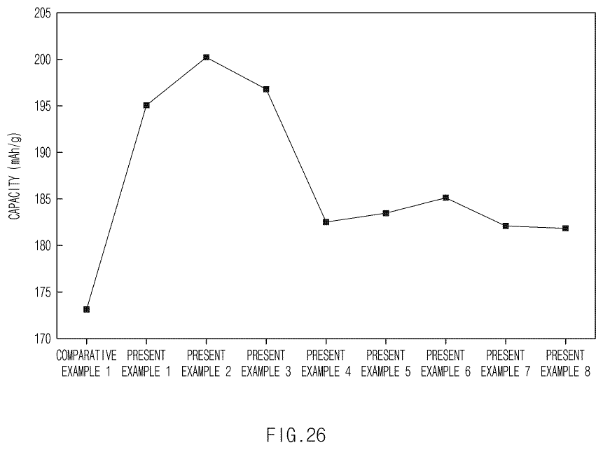

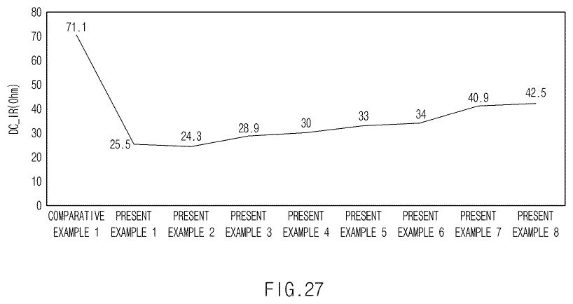

Subsequently, the cell characteristics were measured in the same manner as in Experimental Example 6, and the measurement result together with the result of Present Example 3 and Comparative Example 1 are shown in Tables 6 and 7 below, and the discharge capacity thereof is shown in FIG. 26, and the DC resistance thereof is shown in FIG. 27.

TABLE 6

| | | | Present | Present | Present | Present | Present |
|---|---|---|---|---|---|---|---|
| | | | Example | Example | Example | Example | Example |
| Examples | | | 1 | 2 | 3 | 4 | 5 |
| One | Charge | (mAh/g) | 223.5 | 225.3 | 223.3 | 224.5 | 226.8 |
| time @0.1 C | capacity | | | | | | |
| | Discharge | (mAh/g) | 195.0 | 200.1 | 196.8 | 182.6 | 183.5 |
| | capacity | | | | | | |
| | Efficiency | (%) | 87.2 | 88.8 | 88.1 | 81.4 | 80.9 |
| Two | DC | (Ω) | 25.5 | 24.3 | 28.9 | 30.0 | 33.0 |
| times @0.1 C | resistance | | | | | | |
| Rate | 0.1 C | (mAh/g) | 190.3 | 194.8 | 188.9 | —²⁾ | 173.9 |
| characteristics | 0.2 C | (mAh/g) | 175.7 | 179.0 | 171.5 | —²⁾ | 155.8 |
| | 0.33 C | (mAh/g) | 162.9 | 165.6 | 158.1 | —²⁾ | 141.3 |
| | 0.5 C | (mAh/g) | 151.5 | 154.0 | 144.7 | —²⁾ | 129.6 |
| | 1.0 C | (mAh/g) | 130.5 | 132.7 | 120.2 | —²⁾ | 106.8 |
| | 2.0 C | (mAh/g) | 102.7 | 104.7 | 86.5 | —²⁾ | 74.8 |
| | Retention | (%) | 87.8 | 89.3 | 86.0 | —²⁾ | 85.3 |
| | rate @100 | | | | | | |
| | Cy | | | | | | |

²⁾No measurement

TABLE 7

| | | | | | | Comparative |
|---|---|---|---|---|---|---|
| | | | Present | Present | Present | Example |
| Examples | | | Example 6 | Example 7 | Example 8 | 1 |
| One | Charge | (mAh/g) | 217.8 | 221.9 | 223.1 | 221.5 |
| time @0.1 C | capacity | | | | | |
| | Discharge | (mAh/g) | 185.1 | 182.1 | 181.8 | 173.1 |
| | capacity | | | | | |
| | Efficiency | (%) | 85.0 | 82.1 | 81.5 | 78.1 |
| Two | DC | (Ω) | 34.0 | 40.9 | 42.5 | 71.1 |
| times @0.1 C | resistance | | | | | |
| Rate | 0.1 C | (mAh/g) | 176.4 | 176.8 | 172.5 | 158.5 |
| characteristics | 0.2 C | (mAh/g) | 158.1 | 160.9 | 155.6 | 137.5 |
| | 0.33 C | (mAh/g) | 143.8 | 148.0 | 142.2 | 123.8 |
| | 0.5 C | (mAh/g) | 131.2 | 136.5 | 129.9 | 111.4 |
| | 1.0 C | (mAh/g) | 108.1 | 114.6 | 107.8 | 85.5 |
| | 2.0 C | (mAh/g) | 77.1 | 84.7 | 78.7 | 43.8 |
| | @100 Cy | (%) | 85.4 | 88.9 | 85.9 | 81.9 |

As shown in Tables 6 and 7 above, all the all-solid-state lithium secondary batteries including the positive electrode active materials prepared in Present Examples 1-8 of the present were identified to have significantly improved 5 disclosure discharge capacity, efficiency, DC resistance, rate characteristics, and capacity retention. In particular, all the all-solid-state lithium secondary batteries including the positive electrode active materials prepared in Present Examples 1-3 were identified to have excellent discharge capacity and DC resistance.

### Experimental Example 8: Rate Characteristic Evaluation

Using the positive electrode active materials prepared in Comparative Example 2 above, a cell was prepared in the same manner as in Experimental Example 6.

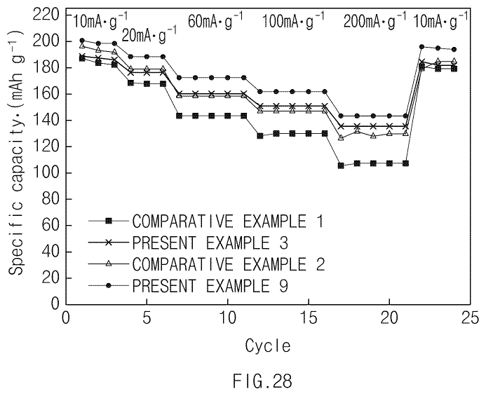

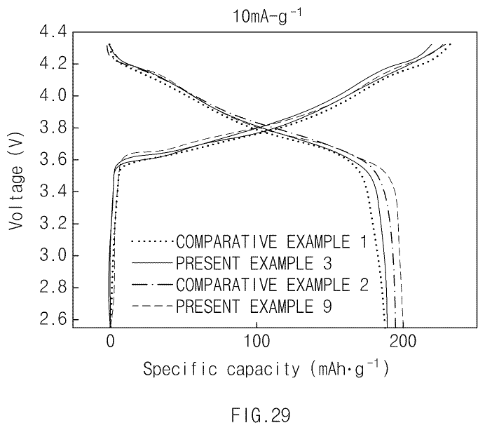

Next, using the cell including the positive electrode active material prepared in each of Present Examples 3 and 9 prepared in Experimental Example 6, and Comparative Example 1, and a cell including the positive electrode active material prepared in Comparative Example 2, the charge and discharge were performed at 10 mA/g for the first to third charge and discharge cycles, 20 mA/g for the fourth to sixth charge and discharge cycles, 60 mA/g for the seventh to eleventh charge and discharge cycles, 100 mA/g for the 12th to 16th charge and discharge cycles, 200 mA/g for the 17th to 21st charge and discharge cycles, and 10 mA/g for the 22nd to 24th charge and discharge cycles at 25° C. in CC/CV mode. The specific capacity (mAh/g) at each charge and discharge cycle is shown in FIG. 28. Furthermore, the initial charge/discharge capacity during the above charge/discharge is shown in FIG. 29.

As may be identified in FIG. 28 and FIG. 29, the positive electrode active material prepared in Present Example 3 was identified to have improved initial capacity and rate characteristics compared to the positive electrode active material prepared in Comparative Example 1. The positive electrode active material prepared in Present Example 3 was identified to have improved rate characteristics compared to Comparative Example 2 including the Li₃PO₄ coating. In particular, the positive electrode active material prepared in Present Example 9 including the Li₃PO₄ coating and the surface-modified area was identified to have improved initial capacity and rate characteristics compared to the positive electrode active material prepared in Comparative Example 2.

### Experimental Example 9: GITT (Galvanostatic Intermittent Titration Technique) Analysis

The cell including the positive electrode active material prepared in each of Present Examples 3 and 9 in Experimental Example 6 above, and Comparative Example 1, and the cell including the positive electrode active material prepared in Comparative Example 2 prepared in Experimental Example 8 above were charged to 4.32 V at 3 C constant current, and then discharged to 2.52 V at 3 C in the CC/CV mode at 25° C. This is one cycle. 300 cycles were executed.

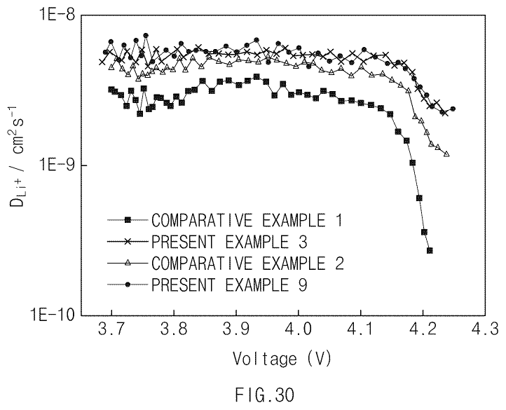

(1) GITT analysis was performed under the conditions of C 10 min pulse and 60 min rest, and the results are shown in FIG. 30.

As may be identified in FIG. 30, the positive electrode active material prepared in each of Present Examples 3 and 9 of the present disclosure exhibited higher lithium ion diffusivity compared to Comparative Examples 1 and 2 throughout an entire range where the charge pulse was applied. In particular, this difference in lithium ion diffusivity was maximized in the high voltage range (4.1 V to 4.3 V).

### Experimental Example 10: Lifetime Characteristics Evaluation 1

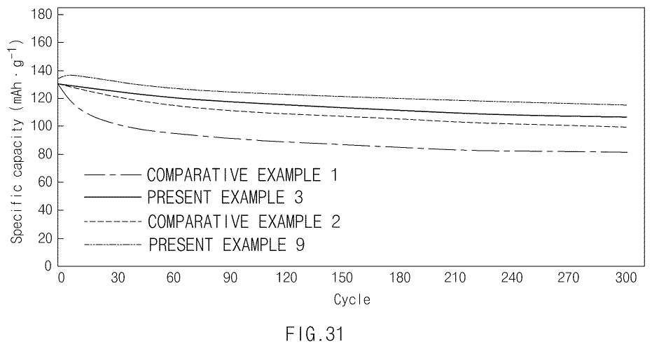

The cell including the positive electrode active material prepared in each of Present Examples 3 and 9 in Experimental Example 6 above, and Comparative Example 1, and the cell including the positive electrode active material prepared in Comparative Example 2 prepared in Experimental Example 8 above were charged to 4.32 V at 3 C constant current, and then discharged to 2.52 V at 3 C in the CC/CV mode at 25° C. This is one cycle. 300 cycles were executed. The specific capacity (mAh/g) at each charge/discharge cycle is shown in FIG. 31.

As may be identified in FIG. 31, the all-solid-state lithium secondary battery including the positive electrode active material prepared in Present Example 3 and 9 exhibited higher specific capacity than Comparative Example 1 and 2 throughout the entire range. In particular, it was identified that the all-solid-state lithium secondary battery including the positive electrode active material prepared in Present Example 9 had significantly improved specific capacity.

### Experimental Example 11: Life Characteristics Evaluation 2

The cell including the positive electrode active material prepared in each of Present Examples 3 and 9 in Experimental Example 6 above, and Comparative Example 1, and the cell including the positive electrode active material prepared in Comparative Example 2 prepared in Experimental Example 8 above were charged to 4.32 V at 3 C constant current, and then discharged to 2.52 V at 3 C in the CC/CV mode at 25° C. This is one cycle. 300 cycles were executed.

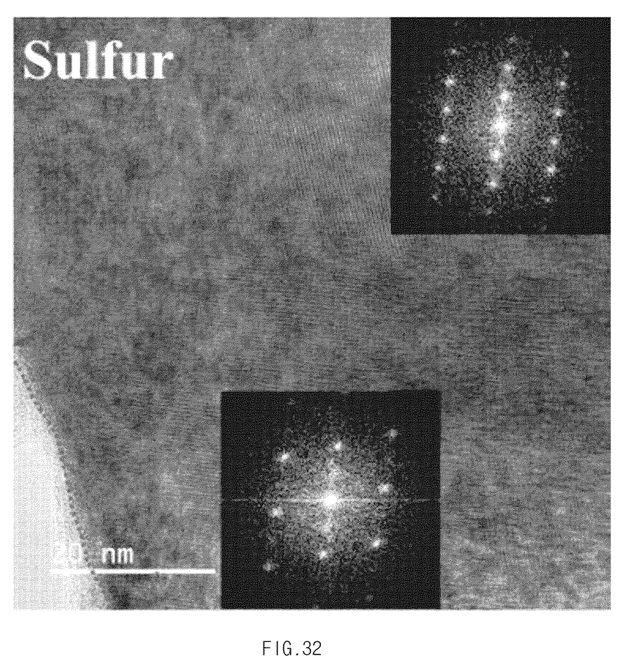

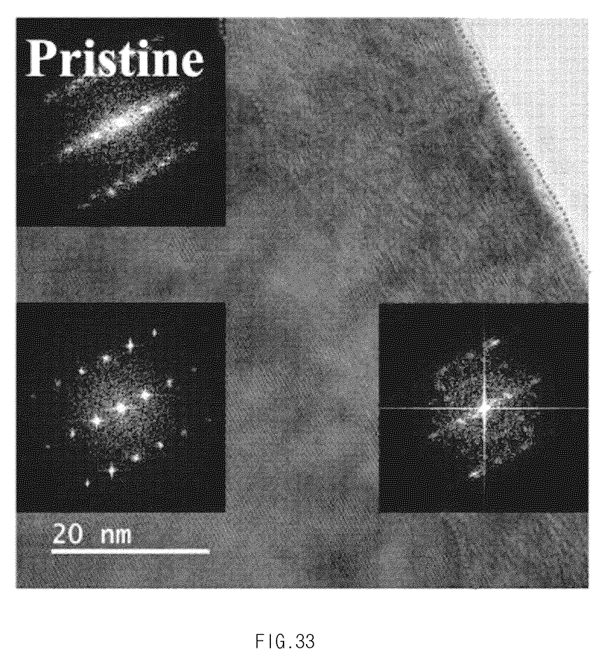

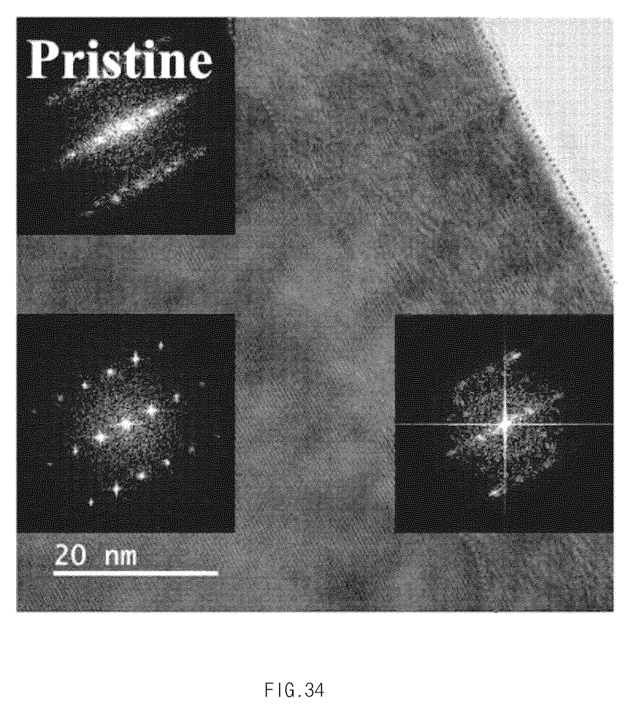

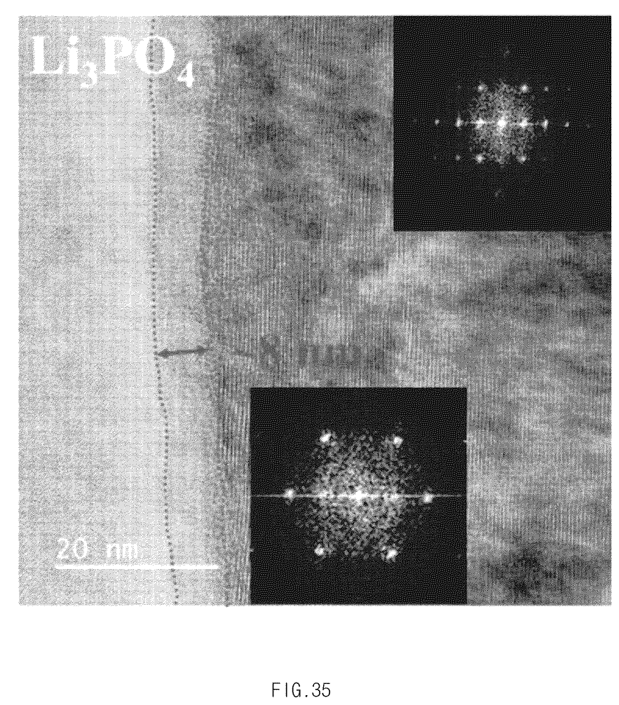

After the 300 charge/discharge cycles were completed, the cell was disassembled to remove the positive electrode active material therefrom. The positive electrode active material of each of Present Example 3 and 9, and Comparative Example 1 and 2 as obtained was cut using FIB (Focused ion beam), and then photographed using a transmission electron microscope (TEM), and the TEM images of the positive electrode active materials are shown in FIG. 32 (Present Example 3), FIG. 33 (Present Example 9), FIG. 34 (Comparative Example 1), and FIG. 35 (Comparative Example 2).

As may be identified in FIG. 32-FIG. 35, it was identified that the positive electrode active material prepared in each of Present Example 3 and 9 included the surface-modified area, and thus had the deterioration of the positive electrode active material surface which was reduced compared to the positive electrode active material prepared in each of Comparative Examples 1 and 2.

From these results, it was identified that the positive electrode active material of the present disclosure included the surface-modified area that had artificially formed the interfacial reaction product on the lithium transition metal composite oxide particle surface through sulfur(S), thereby suppressing the side reaction between the positive electrode active material and the sulfide-based solid electrolyte while improving the compatibility, thereby improving the cycle life and rate performance of an all-solid-state lithium secondary battery.

The positive electrode active material of the present disclosure includes the surface-modified area that has artificially formed an interfacial reaction product on the surface of a lithium transition metal composite oxide particle through sulfur(S), thereby suppressing side reactions between the positive electrode active material and the sulfide-based solid electrolyte, while improving compatibility, thereby improving the life and rate performance of an all-solid-state lithium secondary battery.

Hereinabove, although the present disclosure has been described with reference to embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A positive electrode active material comprising:
a lithium transition metal composite oxide particle; and
a surface-modified area present on at least a portion of a surface of the particle,
wherein the surface-modified area includes a compound represented by Chemical Formula 1 below: 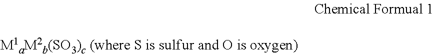
wherein, in Chemical Formula 1,
M¹ includes at least one selected from the group consisting of lithium (Li), boron (B), phosphorus (P), niobium (Nb), zirconium (Zr), aluminum (Al), titanium (Ti), and tantalum (Ta),
M² includes at least one selected from the group consisting of nickel (Ni), cobalt (Co), manganese (Mn), and iron (Fe), and
a satisfies 0≤a≤2, b satisfies 0≤b≤4, c satisfies 1≤c≤4, and at least one of a or b is not 0.

2. The positive electrode active material of claim 1, wherein the surface-modified area further includes a compound represented by Chemical Formula 2 below: 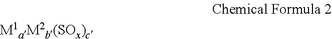
wherein, in Chemical Formula 2,
M¹ includes at least one selected from the group consisting of Li, B, P, Nb, Zr, Al, Ti, at least one selected from the group consisting of Ta,
M² includes at least one selected from the group consisting of Ni, Co, Mn, and Fe,
a′ satisfies 0≤a′≤2, b′ satisfies 0≤b′≤4, c′ satisfies 1≤c′≤4, and at least one of a′ or b′ is not 0, and
x satisfies 1≤x<3 or 3<x≤10.

3. The positive electrode active material of claim 1, wherein in the surface-modified area, a molar ratio of M² to M¹ satisfies Relationship 1 below:
$$0 < [ {M}^{2} ] / [ {M}^{1} ] \leq 0.5 \qquad Relationship 1$$
wherein, in Relationship 1,
M¹ includes at least one selected from the group consisting of Li, B, P, Nb, Zr, Al, Ti, and Ta, and
M² includes at least one selected from the group consisting of Ni, Co, Mn, and Fe.

4. The positive electrode active material of claim 1, wherein the surface-modified area further includes a metal sulfide.

5. The positive electrode active material of claim 1, wherein the surface-modified area contains the compound represented by Chemical Formula 1, among components including a S element, at a highest content.

6. The positive electrode active material of claim 1, wherein a content of a S element in the positive electrode active material as identified by inductively coupled plasma optical emission spectroscopy (ICP-OES) analysis is in a range of 200 ppm inclusive to 20,000 ppm inclusive.

7. The positive electrode active material of claim 1, wherein a distance between an outermost surface (OSM) of the positive electrode active material including a surface-modified area and an interface (ICP) of the surface-modified area and the surface of the particle is defined as A,
wherein a point in the surface-modified area having a distance from the interface or the OSM being 50% of A is defined as a point (A₅₀),
wherein a concentration of a S element in an area (OSM-A₅₀) between the outermost surface (OSM) of the positive electrode active material including the surface-modified area and the point (A₅₀) as identified by XPS analysis is higher than a concentration of the S element in an area (A₅₀-ICP) between the point (A₅₀) and the interface (ICP) between the surface-modified area and the surface of the particle as identified by X-ray Photoelectron Spectroscopy (XPS) analysis.

8. The positive electrode active material of claim 7, wherein the concentration of the S element in the area (A₅₀-ICP) between the point (A₅₀) and the interface (ICP) between the surface-modified area and the surface of the particle has a concentration gradient such that the concentration gradually decreases as the area extends from the point (A₅₀) toward the interface (ICP) between the surface-modified area and the surface of the particle.

9. The positive electrode active material of claim 1, further comprising a coating area present on at least a portion of the surface of the particle.

10. The positive electrode active material of claim 9, wherein the coating area includes at least one selected from the group consisting of lithium carbonate (Li₂CO₃), lithium hydroxide (LiOH), and a compound represented by Chemical Formula 3 below: 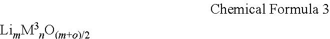
wherein, in Chemical Formula 3,
M³ is at least one selected from the group consisting of Nb, B, P, tungsten (W), Ti, Ta, tin (Sn), Zr, and Al,
m satisfies 1≤m≤10, n satisfies 1≤n≤10, and o is an oxidation number of M³.

11. The positive electrode active material of claim 9, wherein the surface-modified area is present on at least a portion of a surface of the coating area.

12. The positive electrode active material of claim 1, wherein the positive electrode active material is free of a bond (S—P) of a S element and a P element.

13. The positive electrode active material of claim 1, wherein the lithium transition metal composite oxide particle includes at least one selected from the group consisting of a single crystal single-particle, a polycrystalline single-particle, and a secondary particle in which multiple primary particles are aggregated with each other.

14. The positive electrode active material of claim 1, wherein the lithium transition metal composite oxide particle has an average composition represented by Chemical Formula 4 below: 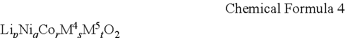
wherein, in Chemical Formula 4,
M⁴ includes Mn, Al, or a combination thereof,
M⁵ includes at least one selected from the group consisting of Nb, Ta, B, Zr, chromium (Cr), and W, and
p satisfies 0.8≤p≤1.3, q satisfies 0<q<1, r satisfies
0<r<1, s satisfies 0<s<1, t satisfies 0≤t≤0.2, and q+r+s+t=1.

15. The positive electrode active material of claim 14, wherein q satisfies 0.8≤q<1, r satisfies 0<r$0.2, s satisfies 0<s≤0.2, and t satisfies 0≤t≤0.1.

16. A positive electrode comprising the positive electrode active material according to claim 1.

17. A lithium secondary battery comprising the positive electrode according to claim 16.

18. The lithium secondary battery of claim 17, further comprising:
a negative electrode; and
a solid electrolyte layer interposed between the positive electrode and the negative electrode.

19. The lithium secondary battery of claim 18, wherein the solid electrolyte layer includes a sulfide-based solid electrolyte.

20. The lithium secondary battery of claim 19, wherein the sulfide-based solid electrolyte includes an argyrodite-type sulfide-based solid electrolyte.
